(19) United States
(12) Patent Application Publication
(10) Pub. No.: US 2025/0375947 A1
(43) Pub. Date: Dec. 11, 2025

(54) DUNNAGE APPARATUS WITH CONICAL INLET

(71) Applicant: Pregis LLC, Chicago, IL (US)

(72) Inventors: Ryan Van Auken, Plainfield, IL (US); David Joyce, Naperville, IL (US); Ken Chess, Hinsdale, IL (US)

(21) Appl. No.: 19/233,874

(22) Filed: Jun. 10, 2025

Related U.S. Application Data
(60) Provisional application No. 63/658,302, filed on Jun. 10, 2024.
(60) Provisional application No. 63/684,815, filed on Aug. 19, 2024.

(51) Int. Cl. B31D 5/00

(52) U.S. Cl. CPC B31D 5/0047; B31D 2205/0035; B31D 2205/0047; B31D 2205/0058

(57) ABSTRACT

Devices for producing dunnage include a crumpler configured to convert a high-density stock material into low-density dunnage, and a former positioned upstream of the crumpler. The outer former has interior surface defining a passage configured to receive the inner former. The interior surface configured to fold the stock material into overlapping layers as the stock material moves through the passage. An outer surface of the inner former opposes and is spaced from the interior surface of the outer former so that the outer surface and the interior surface of the outer former define a channel for receiving the stock material.

### CROSS-REFERENCE TO RELATED APPLICATIONS

This application claims the benefit under 35 U.S.C. § 119 (e) of U.S. Provisional Patent Application No. 63/658,302, filed Jun. 10, 2024, and U.S. Provisional Patent Application No. 63/684,815, filed Aug. 19, 2024. The contents of these applications are incorporated by reference herein in their entirety.

### TECHNICAL FIELD

The present disclosure relates to systems that convert paper stock and other materials into dunnage for use as packing material.

### BACKGROUND

Paper-based protective packaging, or dunnage, is produced by crumpling or otherwise deforming paper stock. More specifically, paper dunnage is produced by running a generally continuous strip of paper through a crumpler. The continuous strip of paper can be provided from, for example, a roll of paper or a fanfold stack of paper. The crumpler converts the stock material into a lower density dunnage material using, for example, opposing rollers between which the stock material is passed. The rollers grip and pull the stock material from the roll or stack, and deform the stock material as the material passes between the rollers. The resulting dunnage can be cut into desired lengths to effectively fill a void space within a container holding a product. The individual pieces of dunnage material may be produced on an as-needed basis for a human operator or automated equipment performing packing operations.

Certain types of dunnage are produced by folding one or more of the sheets of paper stock to produce overlapping layers of the paper stock. The overlying layers are compressed by forming rollers and may be punctured by the forming rollers to discourage separation of the overlying layers form each other. The overlying layers are compressed along a centrally-located portion of the strip of newly-formed dunnage. The side portions of the strip are not compressed and thus have a larger loft that the central portion. While this type of dunnage is generally more robust than other types of dunnage and is suitable for protecting heavier items, the equipment needed to bend the paper stock into the overlapping layers can have a relatively large footprint.

### SUMMARY

In one aspect of the disclosed technology, a device for producing dunnage from a stock material includes a former. The former includes an outer former having an interior surface defining a passage configured to receive the inner former. The interior surface is configured to bend the stock material into overlapping layers as the stock material moves through the passage in a downstream direction with respect to a material path of the stock material.

The former also includes an inner former having an outer surface, at least a portion of the outer surface opposing and being spaced from the interior surface of the outer former so that the outer surface and the interior surface of the outer former define a channel configured to receive the stock material.

The device also includes a crumpler positioned downstream of the former with respect to the material path and configured to compress the overlapping layers of the stock material. The passage has a depth corresponding to a maximum dimension of the passage in a first direction. The first direction coincides with a radial direction within a radial plane about a centerline of the passage. The radial direction intersects a transverse centerline of the stock material within the passage.

The passage has a width equal to a maximum dimension of the passage in a second direction perpendicular to the first direction and the centerline of the passage, and the passage has an aspect ratio defined by the width of the passage to the depth of the passage. The aspect ratio is about 1.7:1 or less along the length of the passage.

In another aspect of the disclosed technology, the aspect ratio of the passage is about equal to or less than 1:1 along the length of the passage.

In another aspect of the disclosed technology, the aspect ratio of the passage is about equal to or less than 0.8:1 along the length of the passage.

In another aspect of the disclosed technology, the inner surface of the outer former defines a cross-sectional perimeter of the passage, and the cross-sectional perimeter of the passage is curved along more than 50 percent of the cross-sectional perimeter.

In another aspect of the disclosed technology, the cross-sectional perimeter of the passage is curved along more than 75 percent of the cross-sectional perimeter.

In another aspect of the disclosed technology, the cross-sectional perimeter of the passage is curved along more than 90 percent of the cross-sectional perimeter.

In another aspect of the disclosed technology, the cross-sectional perimeter of the passage is generally circular or oval.

In another aspect of the disclosed technology, a cross-sectional perimeter of the passage is free of concavities over a distance of more than 1/10 of a transverse dimension of the stock material.

In another aspect of the disclosed technology, the inner former has a frusto-conical configuration.

In another aspect of the disclosed technology, the inner former has a circular transverse cross section or an oval transverse cross section.

In another aspect of the disclosed technology, the passage tapers inward toward the centerline of the passage in the downstream direction over more than 50 percent of a length of the passage.

In another aspect of the disclosed technology, the device further includes a spreader positioned downstream of the inner former with respect to the material path. The interior surface configured to bend the stock material into the overlapping layers to form a tube of the stock material, and the spreader is configured to maintain interior dimensions of the tube.

In another aspect of the disclosed technology, the device further includes an inlet located upstream of the former with respect to the material path and having a forming surface configured to bend the stock material in a direction of the material path while bending side edge portions of the stock material about a longitudinal centerline of the stock material as the stock material is drawn over the forming surface.

In another aspect of the disclosed technology, the inner former is fixed in relation to the outer former.

In another aspect of the disclosed technology, a portion of the inner former extends upstream from an upstream end of the passage to an extent that permits the stock material to be inserted into the channel by pushing the stock material along the outer surface of the inner former.

In another aspect of the disclosed technology, a portion of the inner former extends upstream from an upstream end of the passage to an extent that permits the stock material to be wrapped around the inner former.

In another aspect of the disclosed technology, a first portion of the inner former located downstream of an upstream end of the passage is free of any obstructions around an entirety of an outer perimeter of the first portion of the inner former.

In another aspect of the disclosed technology, the device further includes a support having the inner former mounted thereon so that the support can be positioned between side edges of the stock material when the stock material is wrapped around the inner former.

In another aspect of the disclosed technology, the support ends before a downstream portion of the inner former so that the side edges of the stock material can overlap on the downstream portion of the inner former.

In another aspect of the disclosed technology, the inner former is telescopically disposed in relation to the outer former so that the inner former can at least partially withdraw from the passage.

In another aspect of the disclosed technology, the crumpler includes compression elements configured to compress and puncture the overlapping layers of the stock material along a central portion of the stock material to form the dunnage having a central portion and two lobes adjoining opposite sides of the central portion the dunnage and having a greater loft that the central portion of the dunnage.

In another aspect of the disclosed technology, the compression elements are forming rollers having meshing teeth.

In another aspect of the disclosed technology, the crumpler further includes a housing, and a cover mounted on the housing and configured to move between an open and closed position in relation to the housing. The compression elements are mounted in the housing and/or the cover. The housing and/or the cover define an exit opening configured to allow the dunnage to exit the crumpler, and the exit opening includes a central portion aligned with the compression elements with respect to the material path, and two lateral portions offset from the compression elements with respect to the material path.

In another aspect of the disclosed technology, the central portion of the exit opening is configured to facilitate passage of the central portion of the dunnage through the exit opening, and the lateral portions of the exit opening are configured to facilitate passage of the respective lobes of the dunnage material through the exit opening.

In another aspect of the disclosed technology, the device further includes a cutting mechanism located downstream of the compression members and having a cutter element configured to server the dunnage. The central portion of the exit opening is aligned with the cutter element with respect to the material path.

In another aspect of the disclosed technology, the central portion of the exit opening is sized to prevent fingers from accessing an interior of the crumpler.

In another aspect of the disclosed technology, the device further includes outfeed rollers located between the cutting mechanism and the exit opening and configured to move the dunnage toward the exit.

In another aspect of the disclosed technology a system for producing dunnage includes
the above device of claim 1, and a supply unit of the stock material.

In another aspect of the disclosed technology, a width of the stock material is sufficiently greater than a perimeter of the interior surface of the outer former at a downstream end of the passage such that opposing side portions of the stock material overlap at the downstream end of the passage.

In another aspect of the disclosed technology, a device for producing dunnage from a stock material includes a former. The former includes an outer former having an interior surface defining a passage configured to receive the inner former. The interior surface is configured to bend the stock material into overlapping layers as the stock material moves through the passage in a downstream direction with respect to a material path of the stock material to form a tube of the stock material.

The former also includes an inner former having an outer surface. At least a portion of the outer surface opposes and is spaced from the interior surface of the outer former so that the outer surface and the interior surface of the outer former define a channel configured to receive the stock material.

The device also includes a spreader positioned downstream of the inner former with respect to the material path, and a crumpler positioned downstream of the separator with respect to the material path and including compression members configured to compress a central portion of the overlapping layers of the stock material in a first direction. The spreader is configured to maintain interior dimensions of the tube.

In another aspect of the disclosed technology, the spreader is configured to maintain the interior dimensions of the tube as the central portion of the overlapping layers of the stock material are compressed.

In another aspect of the disclosed technology, the spreader is configured to maintain a first interior dimension of the stock material in a second direction perpendicular to the first direction and the material path, and to maintain a second interior dimension of lateral portions of the stock material in the first direction.

In another aspect of the disclosed technology, the spreader is configured to maintain the second interior dimension of lateral portions of the stock material in the first direction so that the lateral portions of the stock material define lobes in the dunnage as the central portion of the overlapping layers of the stock material are compressed.

In another aspect of the disclosed technology, the spreader includes a first and second lobe.

In another aspect of the disclosed technology, the spreader is configured to spread the bended stock material in the second direction.

In another aspect of the disclosed technology, the spreader includes a first and a second lobe.

In another aspect of the disclosed technology, the first and second lobs are rods.

In another aspect of the disclosed technology, the first and second lobes are parallel.

In another aspect of the disclosed technology, the first and second lobes are fixed to a downstream end of the inner former at opposite ends of the downstream end.

In another aspect of the disclosed technology, the first and second lobes are offset from the compression members in the second direction, and the first and second lobes are configured to direct the lateral portions the stock material from away from the compression members.

In another aspect of the disclosed technology, a device for producing dunnage from a stock material includes an inlet having a forming surface configured to bend the stock material in a direction of a material path of the stock material through the device while bending side edge portions of the stock material about a longitudinal centerline of the stock material as the stock material is drawn over the forming surface.

The device also includes a former positioned downstream of the inlet with respect to the material path. The former includes an outer former having an interior surface defining a passage configured to receive the inner former. The interior surface is configured to bend the stock material into overlapping layers as the stock material moves through the passage in a downstream direction with respect to a material path of the stock material.

The device also includes an inner former having an outer surface. At least a portion of the outer surface opposes and is spaced from the interior surface of the outer former so that the outer surface and the interior surface of the outer former define a channel configured to receive the stock material. The device also includes a crumpler positioned downstream of the former with respect to the material path and configured to compress the overlapping layers of the stock material.

In another aspect of the disclosed technology, the forming surface is configured to bend the side edge portions of the stock material downward with respect to the longitudinal centerline of the stock material.

In another aspect of the disclosed technology, the forming surface is U-shaped and is configured to impart a U-shaped bend to the stock material.

In another aspect of the disclosed technology, the forming surface is configured to bend the stock material toward the former.

In another aspect of the disclosed technology, the inlet has a body that includes the forming surface, the inlet further includes an upper member configured to restrain the stock material from upward movement, and the forming surface and the upper portion of the inlet define a portion of the material path of the stock material.

In another aspect of the disclosed technology, the inlet has a body that includes the forming surface, and the inlet further includes a forming member fixed to the body and configured to turn the stock material in the direction of the material path while bending the side edge portions of the stock material about the longitudinal centerline of the stock material before the stock material reaches the forming surface.

In another aspect of the disclosed technology, the forming member is narrower than the forming surface with respect to a direction transverse to the material path.

In another aspect of the disclosed technology, a system for producing dunnage includes the above device and a supply unit of the stock material. The inlet is configured to cause the stock material to undergo an obtuse bend when moving between the supply unit and the former.

### BRIEF DESCRIPTION OF DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a perspective view of a device for producing dunnage, with an inner former of the device in an open position of the inner former, and with a cover of the device in an open position of the cover;

FIG. 2 is a perspective view of the device shown in FIG. 1, with the inner former and the cover in their respective open positions;

FIG. 3 is a cross-sectional view taken through the line “III-III” of FIG. 1;

FIG. 4 is a cross-sectional view taken through the line “IV-IV” of FIG. 1;

FIG. 5 is a diagrammatic cross-sectional view taken through the line “V-V” of FIG. 3, depicting stock material being folded in the former of the device shown in FIG. 1;

FIG. 6 is a diagrammatic cross-sectional view taken through the line “VI-VI” of FIG. 3, depicting the stock material being further folded in the former of the device shown in FIG. 1;

FIG. 7 is a diagrammatic cross-sectional view taken through the line “VII-VII” of FIG. 3, depicting the stock material after being formed into dunnage;

FIG. 8 is a front or rear view of dunnage produced by the device shown in FIG. 1;

FIG. 9 is a cross-sectional perspective side view of forming rollers of the device shown in FIG. 1;

FIG. 10 is a perspective view of an alternative embodiment of the former of the device shown in FIG. 1;

FIG. 11 is a perspective view of another alternative embodiment of the former of the device shown in FIG. 1, with a top portion of an outer former of the former in an open position;

FIG. 12 is a diagrammatic illustration of various electrical and electronic components of the device shown in FIG. 1;

FIG. 13 is a perspective view of an alternative embodiment of the device shown in FIG. 1, with a cover of the device in an open position of the cover;

FIG. 14 is a perspective view of the device shown in FIG. 13, with a cover of the device in an intermediate position between the open and closed positions of the cover;

FIG. 15 is a perspective view of the device shown in FIGS. 13 and 14, with a cover of the device in the closed position of the cover;

FIG. 16 is a perspective view of outfeed rollers of the device shown in FIGS. 1-8 and 12;

FIG. 17 is a cross-sectional perspective view of a belted outfeed unit;

FIG. 18 is a perspective view of another belted outfeed unit;

FIG. 19 is a perspective view of the belted outfeed unit shown in FIG. 18, with a portion of the unit removed for clarity of illustration;

FIG. 20 is a perspective view of a cutting mechanism of the device shown in FIG. 1, depicting a cutting blade of the cutting mechanism and a stowed position;

FIG. 21 is a front view of an exit opening of the device shown in FIG. 1, depicting a piece of dunnage exiting the device by way of the exit opening;

FIG. 22 is a perspective view of a supply unit of the stock material used in the device shown in FIG. 1;

FIG. 23 is a perspective view of an alternative embodiment of the device shown in FIG. 1;

FIG. 24 is a side view of the device shown in FIG. 23;

FIG. 25 is a cross-sectional view of the device shown in FIGS. 23 and 24, taken through the line XXV-XXV of FIG. 23;

FIG. 26 is a perspective view of a former of the device shown in FIGS. 23-25;

FIG. 27 is a perspective view of an alternative embodiment of the device shown in FIG. 1;

FIG. 28 is a side view of the device shown in FIG. 27; and

FIG. 29 is a side view of the device shown in FIGS. 27 and 28, showing the device drawing stock material from a supply unit of the stock material.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

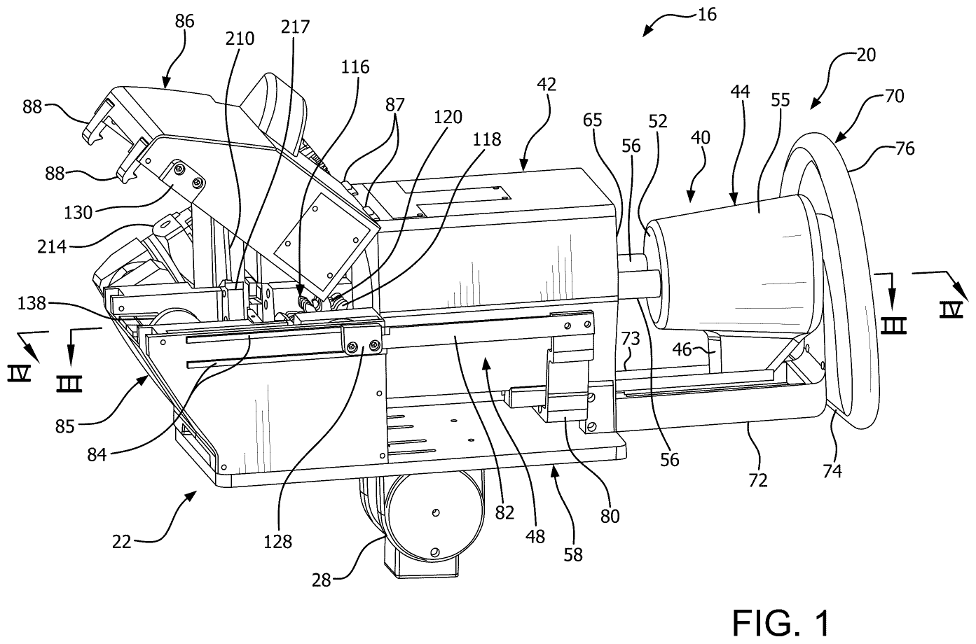

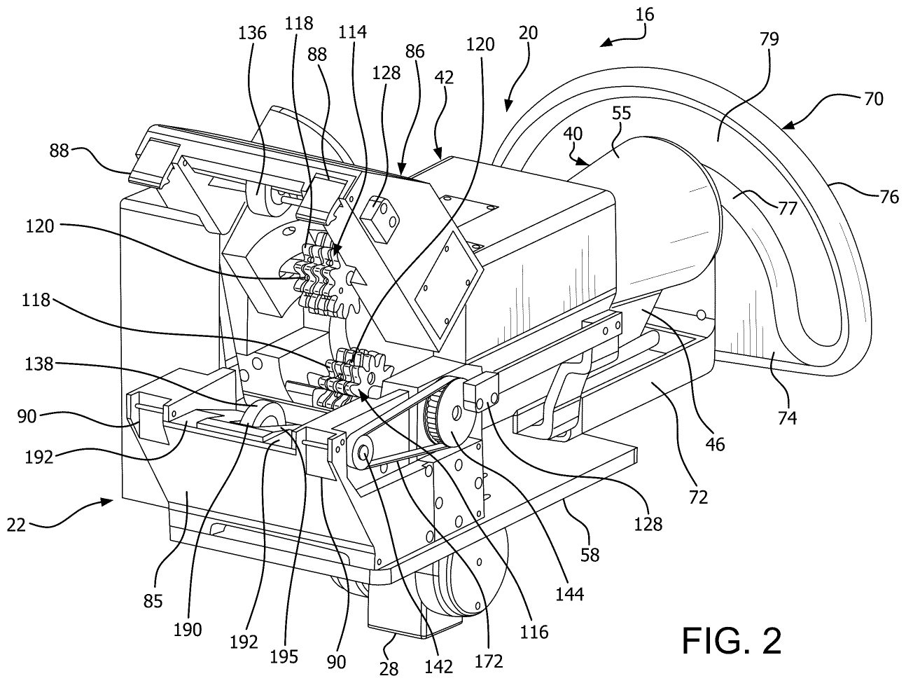

Directional terms such as “top,” “bottom,” “upper,” “lower,” etc. are used in relation to the component orientations depicted in FIGS. 1 and 2. These terms are used for illustrative purposes only and are not intended to limit the scope of the appended claims.

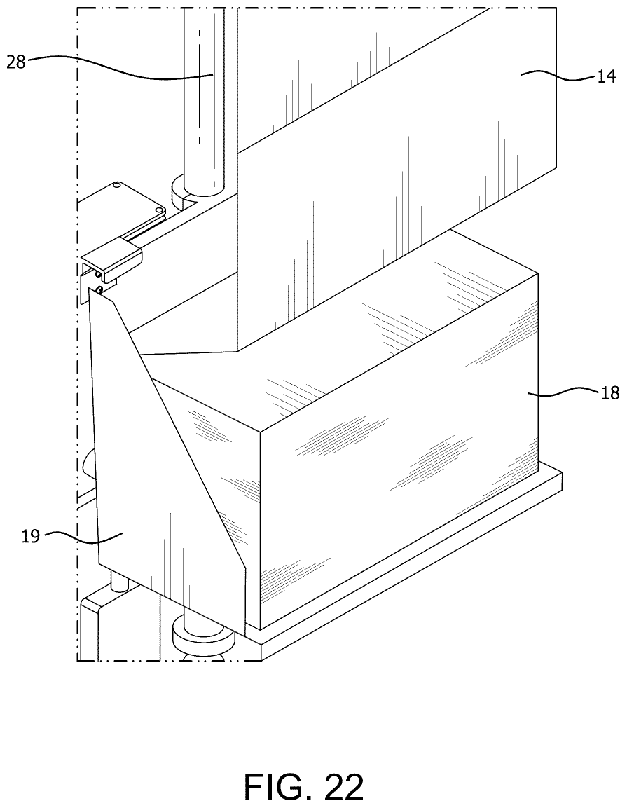

The figures depict a device 16 for producing dunnage 12 from a stock material 14. The stock material can be provided as a supply unit 18 of the stock material 14, shown in FIG. 22. The device 16 and the supply unit 18 form a system for producing dunnage. The supply unit 18 is depicted as a stack of fan-folded stock material 14 for illustrative purposes only. The supply unit 18 can have other configurations, such as a roll of the stock material 14, in the alternative.

The device 16 includes a former 20, and a crumpler 22. The device 16 can be configured to rest directly on a supporting surface (not shown), such as the upper surface of a workstation at which items are packaged. Alternatively, the device 16 can be mounted on and supported by a support 28, a portion of which is depicted in FIG. 2.

The former 20 is configured to direct the stock material 14 to the crumpler 22, while bending the stock material 14 into a shape that makes the stock material suitable 14 for being fed into the crumpler 22. The crumpler 22 converts the pre-formed stock material 14 into the lower density dunnage 12 having a relatively thin central portion or spine 24, and two thicker lobes 26 that adjoin opposite sides of the spine 24.

Protective packaging articles are configured for placement within a packaging container or between packaging containers or items being shipped or stored, to protect items, fill void space within a container, such as a packaging container, and/or prevent or inhibit the items from moving around within the container. While there is overlap between the following categories, example categories of protective packaging articles include protective-fill articles, and block-and-brace articles.

Protective-fill articles are typically provided individually or as a plurality of units that are configured for placing into the void space to provide a desired level of packaging. Such units typically are of a predetermined size or can have a predetermined dimensions and be selectively configurable in another dimension, such as length. In some examples, the size of the protective-fill articles can be configurable in a plurality or all of their dimensions. Protective-fill articles are typically resiliently compressible to around corners, edges, and sides of a packaged item to fill the space around the item, instead of assuming a solid shape that corresponds to the space around the item. Protective-fill articles include, for example, void-fill articles and cushioning articles.

Void-fill articles typically provide minimal cushioning properties and are relatively soft. They are typically used to fill empty void space in packaging containers to reduce the movement within the container of lightweight items that are not delicate, such as a thin book. An example of void-fill includes crumpled-paper dunnage with a fairly weak loft pattern and other space fillers that are easily compressible.

Cushioning articles are configured to provide cushioning to the packaged items and protection to various degrees against shocks and impact. Examples of cushioning materials include inflatable air pillows and cushions, bubble wrap, paper dunnage with a loft structure capable of withstanding moderate shocks and impact, foam sheets, and packing peanuts.

Typically, both void-fill and cushioning articles are provided as a plurality of units of one or more similar sizes, typically common predetermined sizes, although in some applications the void-fill or cushioning articles can be made to custom sizes. Some cushioning articles are also packaging containers, such as padded mailers or other containers with a padded wall.

The plurality of void-fill or cushioning articles that are used is typically selected to sufficiently fill the void space within the container to serve the desired protective function. Some void-fill or cushioning articles can be used to enclose or otherwise surround an item, such as expandable-paper or bubble wrap that can be used to wrap an item, such as a bottle.

Block-and-brace articles are configured to restrain packaged items from substantial movement in relation to the packaging container and often provide the highest level of protective cushioning and impact resistance and are typically configured in association with the container, typically a box, to stabilize the item within the container and minimize or prevent its movement.

Block-and-brace articles tend to be used with heavy and/or delicate bulky items to protect them against breakage during shipping. Some block-and-brace articles are formed around an item being packaged within void space in a container, others are pre-formed to receive or fit against the packaged item and to fit precisely within the container to prevent movement of the item, and others are folded or shaped prior to insertion of the item into the container. Examples of block-and-brace articles are foam-in-place or foam-in-bag articles, which are typically formed by mixing foam precursors and injecting the mixture into flexible bags, such as made of poly film; the filled bags are placed in the box or other container with the item, and the precursor mixture foams to several hundred times its original size, filling the void between the item and the container, and then solidifying into a custom shape. Other examples include molded foam blocks, such as polystyrene, or cardboard forms that conform to the shape of the packaged item and the container. Block and brace also can include paper block and brace articles that with an elevated stiffness; these are often formed by multiple plies of paper and are produced to lock in fold or other shape in the paper that provides loft.

Block-and-brace typically receives and traps corner, edge, or other surface of the item within the box. Block and brace is typically used to protect heavy and delicate item during shipping, such as a large television set or an automobile clutch.

Protective articles that include an amount of padding, such as void-fill, cushioning, and block-and-brace, can be provided in their operable configuration, or can be provided in a high-density configuration and then expanded, such as a customer site, to a low-density configuration that provides the requisite amount of padding or thermal insulation. Examples of expandable materials and construction for the expandable articles include inflatable films and webs, paper that is crumpled or manipulated by a device to crease the paper to maintain loft, and chemical foams.

The stock material 14 can be stored in the form of a roll (whether drawn from inside or outside the roll), a wind, a fan-folded source, or other suitable form. The stock material 14 can be continuous or perforated. The device 16 is fed the stock material 14 from the supply unit 18 in a first, or downstream direction, which can be an anti-run out direction.

The supply unit 18 of stock material 14 can be held, for example, in a supply station 19 mounted on the support 28, depicted in FIG. 22. The supply station 19 can have a basket-type configuration. The supply station 19 can have other configurations suitable for supporting the supply unit(s) 18 in single bundles; in multiple daisy chained bundles; in a flat configuration; in a rolled configuration; and/or in a curved configuration.

The stock material 14 can be any suitable type of protective packaging material including, for example, flat or rolled paper stock or fiber-based materials in sheet form. Other embodiments can use supplies of wound fiber material such as ropes or thread. Other embodiments can use thermoplastic materials such as a web of plastic material usable to form pillow packaging material. The stock material 14 can be configured in a fan-folded supply unit 18 having, for example, 30-inch transverse width or a 15-inch transverse width. The sheets can be fan folded in single layers. In other embodiments, the multiple layers of sheets can be fan folded together such that dunnage is made of superimposed sheets that are crumpled together in the conversion process.

The stock material 14 can be, for example, paper stock stored in a high-density configuration, and subsequently converted into the low-density dunnage 12 by the crumpler 22. The stock material 14 can have a basis weight of, for example, about 20 lbs. per 3,000 square feet to about 100 lbs. per 3,000 square feet. For example, the stock material 14 can have a basis weight of 30 pounds per 3,000 square feet, 45 pounds per 3,000 square feet, 50 gsm, or 70 gsm. The stock material 14 can have other basis weights. The stock material 14 can be configured as a ribbon of sheet material that is stored in a fan-fold structure; or in coreless or cored rolls. The stock material 14 can be formed or stored as single-ply or multiple plies of material. Where multi-ply material is used, a layer can include multiple plies. Other types of materials of suitable thickness, weight, and dimensions can be used as the stock material 14, such as pulp-based virgin and recycled papers, newsprint, cellulose and starch compositions, and poly or synthetic material.

The supply units 18 of stock material 14 can have a fan-fold configuration as shown in FIG. 22. For example, a foldable material, such as paper, may be folded repeatedly to form a stack or a three-dimensional body. The term “three-dimensional body,” in contrast to the “two-dimensional” material, has three dimensions all of which are non-negligible. A continuous sheet, e.g., a sheet of paper, plastic, or foil, can be folded at multiple fold lines that extend transversely to a longitudinal direction of the continuous sheet, or transversely to the feed direction of the sheet. For example, folding a continuous sheet that has a substantially uniform width along transverse fold lines can form or define sheet sections that have approximately the same width. The continuous sheet can be folded sequentially, in opposite or alternating directions, to produce an accordion-shaped continuous sheet. For example, the folds may form or define sections along the continuous sheet, and the sections may be substantially rectangular.

For example, sequentially folding the continuous sheet may produce an accordion-shaped continuous sheet with sheet sections having approximately the same size and/or shape as one another. Multiple adjacent sections that are defined by the fold lines can be generally rectangular, and can have the same first dimension, e.g., a dimension corresponding to the width of the continuous sheet, and the same second dimension that is generally along the longitudinal direction of the continuous sheet. For example, when the adjacent sections are contacting one another, the continuous sheet may be configured as a three-dimensional body or a stack, in an accordion shape that is formed by the folds and be compressed, so that the continuous sheet forms a three-dimensional body or stack.

The fold lines of the stock material 14 can have any suitable orientation relative to one another, as well as relative to the longitudinal and transverse directions of the continuous sheet. Also, the supply unit 18 of the stock material 14 can have transverse folds that are parallel one to another. For example, the sections that are formed by the fold lines can be compressed to form a three-dimensional body that is a rectangular prismoid. Also, the stock material 14 can have one or more folds that are non-parallel relative to the transverse folds.

The stock material 14 can be provided as any suitable number of the discrete supply units 18. In some embodiments, two or more of the supply units 18 can be connected together to provide a continuous feed of the stock material 14 into the device 16. The stock material 14 can be fed from the connected supply units 18 sequentially or concurrently, i.e., in series or in parallel. The supply units 18 can have various suitable sizes and configurations and may include one or more stacks or rolls of suitable sheet materials. The term “sheet material” refers to a material that is generally sheet-like and two-dimensional, i.e., two dimensions of the material are substantially greater than the third dimension so that the third dimension is negligible or de minimis in comparison to the other two dimensions. Also, the sheet material can be generally flexible and foldable, such as the illustrative materials described herein.

The supply units 18 can include an attachment mechanism that connects multiple supply units 18, for example, to produce a continuous material feed from multiple discrete supply units 18. The respective end and beginning of consecutive rolls can be joined by adhesive or other suitable means, to facilitate daisy-chaining the rolls together to form a continuous stream of sheet material that can be fed to the device 16.

Folding a continuous sheet along the transverse fold lines can form or define generally rectangular sheet sections of a fan-folded stock material unit. The rectangular sheet sections can stack together by, for example, folding the continuous sheet in alternating directions, to form the three-dimensional body that has longitudinal, transverse, and vertical dimensions.

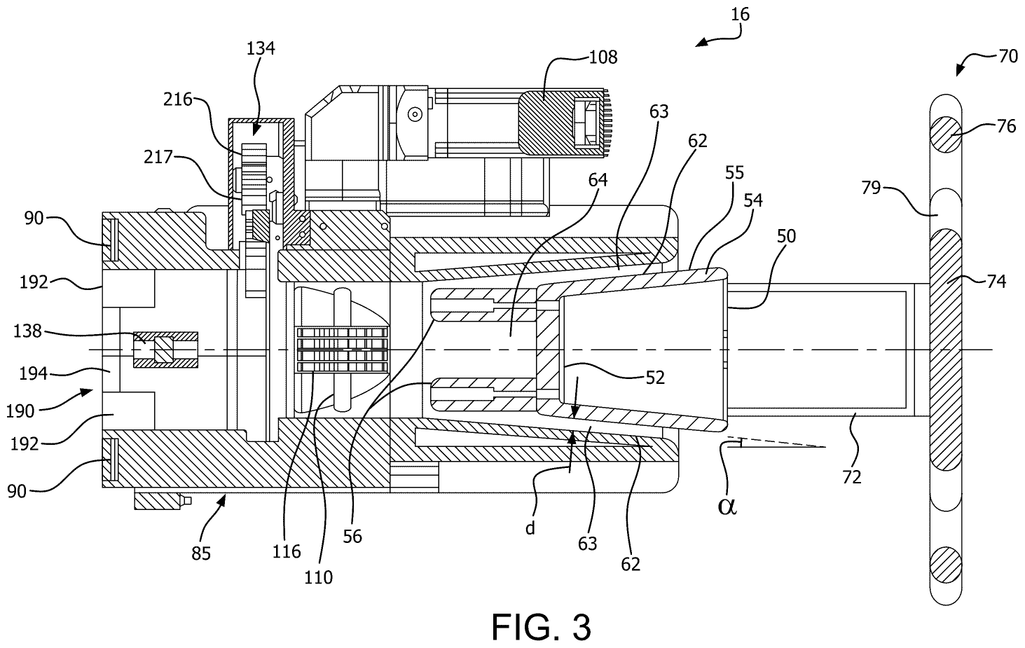

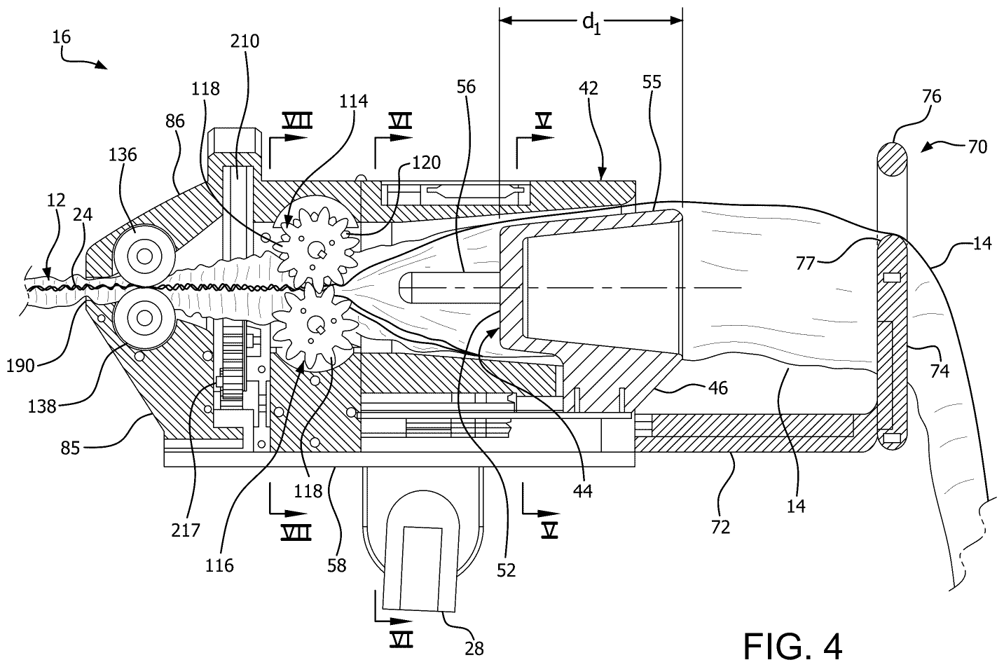

The former 20 includes an inner former 40 and an outer former 42. The inner former 40 is movable in relation to the outer former 42 between open, or load position shown in FIGS. 1 and 2, and a closed, or run position shown in FIGS. 3 and 4. The inner former 40 includes a body 44. The inner former 40 also includes a mount 46 that is connected to and extends downward from the body 44. The former 20 also includes a guide 48 that is connected to and extends from the mount 46 in the forward, i.e., downstream, direction.

The body 44 has a frusto-conical configuration. In particular, the body 44 has a substantially planar upstream or rear wall 50, a substantially planar downstream or forward wall 52, and a curvilinear sidewall 54 that adjoins the rear and forward walls 50, 52. The body 44 has a circular transverse cross section that steadily decreases in diameter as the body 44 extends from the rear wall 50 the forward wall 52. The body 44 can have a non-circular transverse cross section in alternative embodiments. For example, the transverse cross section of the body 44 can be oval in alternative embodiments.

As discussed below, the stock material 14 is loaded onto the crumpler 22 by partially wrapping the leading end of the stock material 14 around the sidewall 54 of the body 44 while the inner former 40 is in its open position. As can be seen in FIG. 1, the body 44 is located completely outside of the outer former 42 when the inner former 40 is in its open position, so that a space 65 is defined between the forward wall 52 of the body 44 and the rearward, or upstream end of the outer former 42. In addition to wrapping the leading end of the stock material 14 around the body 44, the operator can push the stock material 14 into the outer former 42 via the space 65. The inner former 40 then is moved to its closed position from which stock material 14 can be drawn into the crumpler 22 and converted into the dunnage 12 as discussed below. The distance d₁ by which the front wall 52 translates when the inner former 44 moves between its open and closed positions is denoted in FIG. 4. The inner former 44 can pivot or translate in a non-linear manner when moving between its open and closed positions, in alternative embodiments.

An outer surface 55 of the sidewall 54 can be angled in relation to the longitudinal direction of the body 44 by an angle denoted in the figures by the reference character a. The inner former 40 can translate, for example, by about 158 mm when moving between its open and closed positions. This particular value for the extent of movement of the inner former 40 is presented for illustrative purposes only and can differ in alternative embodiments of the former 20.

The sidewall 54 is depicted as having a continuous configuration. In alternative embodiments, the sidewall 54 have a ribbed or other type of non-continuous configuration sufficient to support the stock material 14 in the below-noted manner as the stock material 14 moves over the inner former 40. In other alternative embodiments, the body 44 can be formed from wire or rods connected in a suitable manner to provide the body 44 with the shape and rigidity need to support the stock material 14 as discussed below as the stock material 14 moves over the inner former 40.

The device 16 further includes a spreader. The spreader can be configured, for example, as two lobes. In some embodiments, the lobes can be cylindrical rods 56 mounted on the forward wall 52 of the body 44 and extending from the forward wall 52 in a downstream direction, as can be seen in FIGS. 1, 3, 4, 6, and 7. The rods 56 are spaced apart, and are located proximate the outer periphery of the forward wall 52, at the approximate 3:00 o'clock and 9:00 o'clock positions, respectively. Each rod 56 can have a length of, for example, about 83 mm. This specific length is presented for illustrative purposes only, and can differ in alternative embodiments of the former 20. As discussed below, the rods 56 further guide and shape the stock material 14 before the stock material reaches the crumpler 22.

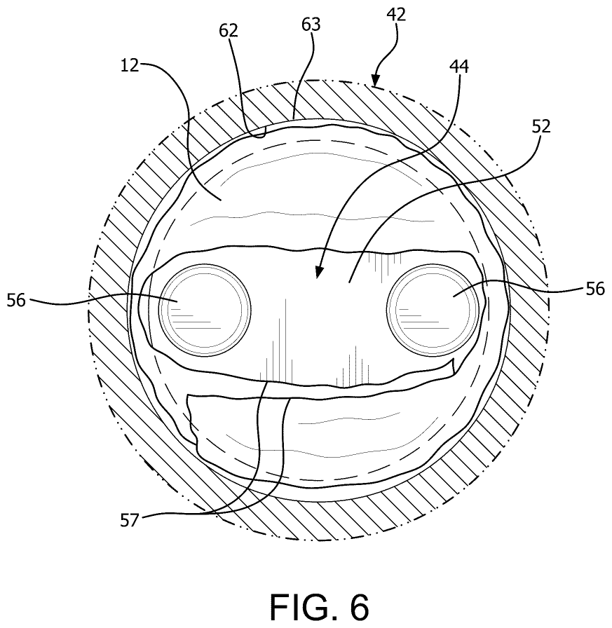

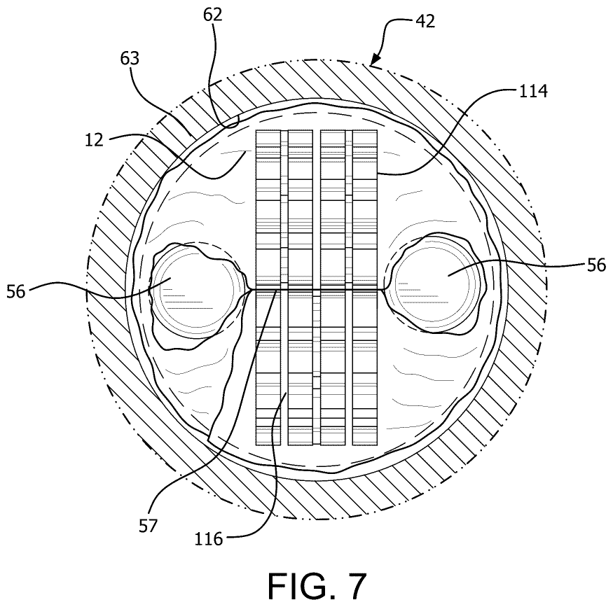

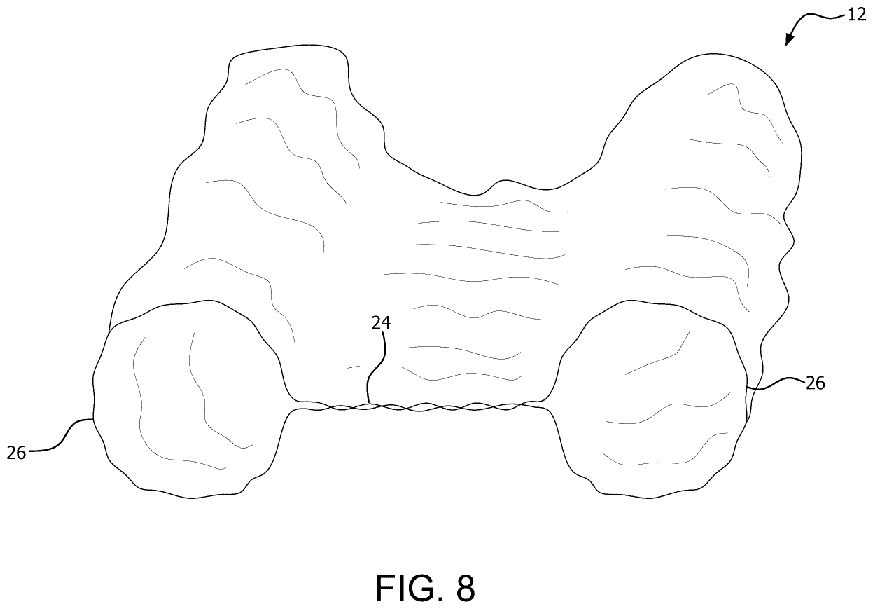

The spreader can have a configuration other than the rods 56 in alternative embodiments. For example, the spreader can be configured as a single structure having the approximate shape of a FIG. 8, when viewed from the perspective of FIGS. 6 and 7.

The outer former 42 is mounted on a frame 58 of the device 16. The outer former 42 includes an interior surface 62 having a shape and a contour that approximately match those of the side surface 55 of the body 44 of the inner former 40. The interior surface 62 defines a passage 64. As can be seen in FIGS. 3 and 4, a portion of the body 44 is configured to fit within the passage 64 when the inner former 40 is in its closed position, with minimal clearance between the interior surface 62 and the outer surface 55 of the body 44 so that a forming area or channel 63 is defined between the interior surface 62 and the outer surface 55. The channel 63, i.e., the distance “d” between the interior surface 62 and the outer surface 55 as denoted in FIG. 3, can be, for example, about 6 mm. This particular value is presented for illustrative purposes only and can vary in alternative embodiments. As discussed below, the channel 63 allows the stock material 14 to be drawn through the space between the interior surface 62 and the outer surface 55 as the stock material 14 is drawn through the former 20.

The passage 64 has a depth corresponding to a maximum dimension of the passage 64 in a first direction. The first direction coincides with a radial direction within a radial plane about a centerline of the passage 64. The radial direction intersects a transverse centerline of the stock material 14 within the passage 64. The passage 64 has a width equal to a maximum dimension of the passage 64 in a second direction perpendicular to the first direction and the centerline of the passage 64. The passage 64 has an aspect ratio defined by the width of the passage 64 to the depth of the passage 64. Because the passage 64 is circular, the aspect ratio of the passage 64 is about 1:1 along the length of the passage 64. In some embodiments, the aspect ratio can be about 1.7:1 or less along the length of the passage 64. In some embodiments, the aspect ratio can be about 0.8:1 along the length of the passage 64. The body 44 can have an aspect ratio similar or identical to that of the passage 64.

The former 20 also includes an inlet 70 and a support 72. A forward or downstream end of the support 72 is connected to the outer former 42, so that the support 72 is suspended from the outer former 42 in a cantilevered arrangement. The inlet 70 is mounted on the rearward, or upstream end of the support 72. In addition to supporting the inlet 70, the support 72 receives a rearward portion 73 of the guide 48 of the former 20 and supports the guide 48 and the attached inner former 40 as the inner former 40 moves between its closed and open positions.

The inlet 70 includes a body 74, and an upper member 76 that is connect to and extends over the body 74. The upper member 76 can be configured as a curved bar, as shown in FIGS. 1 and 2. The upper member 76 can have other configurations in alternative embodiments. The body 74 is mounted on the rearward or upstream end of the support 72.

The body 74 has a rounded forming surface 77. The forming surface 77 is spaced from the upper member 76 by a channel 79. The web of stock material 14 is drawn over the forming surface 77, and through the channel 79, as the web of stock material 14 is drawn into the former 20. The forming surface 77 provides initial breakage of the flat web of stock material 14 into a curved shape and centers the web if the stack or roll from which the web is being drawn is misaligned with the former 20. Also, the forming surface 77 can turn, or change the general path of the web by an obtuse angle, for example, by about 45 degrees to about 135 degrees, depending on the orientation of the crumpler 22. The forming surface 77 bends the stock material 14 in a direction of a material path of the stock material while bending side edge portions of the stock material 14 about a longitudinal centerline of the stock material 14 as the stock material is drawn over the forming surface 77. In some embodiments, the forming surface 77 is U-shaped and imparts a U-shaped bend to the stock material 14 as it bends the side edge portions of the stock material 14 downward with respect to the longitudinal centerline of the stock material 14, and toward the former 20.

As can be seen in FIG. 1, the guide 48 of the former 20 includes the rearward portion 73, an intermediate portion 80 that adjoins the rearward portion 73, and a forward portion 82 that adjoins the intermediate portion 80. The forward portion 82 engages guide rails 84 on the outer former 42 as the inner former 40 moves between its open and closed positions. The guide rails 84 guide and support the guide 48 as the inner former 40 moves between its open and closed positions. Alternative embodiments of the device 16 can be configured without the inlet 70.

The stock material 14 is loaded manually by the operator. In particular, the operator can move the inner former 40 from its closed position to its open position by pulling the inner former 40 in the rearward, or upstream direction. Once the inner former 40 is in the open position, the operator can wrap the leading end of a new stack or roll of the stock material 14 from the supply unit 18 or other source around the body 44 of the inner former 40 as discussed above. In addition, the operator can push the stock material 14 into the passage 64 within the outer former 42 by way of the space 65 between the forward wall 52 of the body and the rearward end of the outer former 42, so that the leading edge of the stock material 14 is located downstream of the downstream ends of the rods 56, which in turn allows the stock material 14 to be entrained by the crumpler 22 as discussed below.

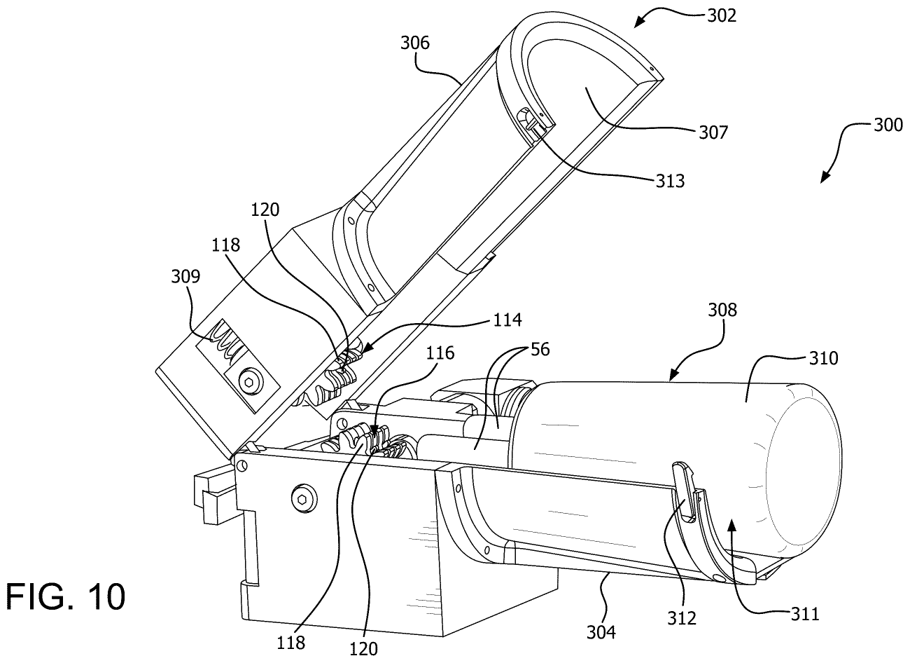

FIG. 10 depicts an alternative embodiment of the former 20 in the form of a former 300. The former 300 is depicted as being fixed to a crumpler 301 similar to the crumpler 22.

The former 300 includes an outer former 302 having a stationary lower portion 304, and an upper portion 306 coupled to the lower portion 304 by pins 305 or other suitable devices that permit the upper portion 306 to pivot in relation to the lower portion 304. The former 300 also includes an inner former 308 that is mounted on the lower portion 304 of the outer former 302, so that the inner former 308 is fixed in relation to the lower portion 304. The upper portion 306 is depicted in an upper or loading position at which the stock material 14 can be wrapped around a body 310 of the inner former 308 as discussed above in relation to the former 20. The body 310 is substantially similar structurally and functionally to the body 44 of the inner former 40, with the exception that the body 310 is elongated in comparison to the body 44.

The upper portion 306 can rotate to a closed position at which the upper portion 306 and the lower portion 304 enclose the inner former 308 so that an interior surface 307 of the outer former 302 opposes and is spaced apart from an outer surface of the body 310, thereby defining a channel 311 between the interior surface 307 and the outer surface of the body 310. The channel 311 is configured to receive the stock material 14 as discussed above in relation to the former 20. The former 300 includes latches 312 on the lower portion 304 of the outer former 302. The latches 312 are configured to engage corresponding latching features 313 on the upper portion 306 to secure the upper portion 306 in its closed position. The former 300 can include other suitable features to secure the upper portion 306 in its closed position. FIG. 10 also depicts a spring 309 of the crumpler 301. The spring 309 is configured to bias upper forming rollers 114 toward lower forming rollers 116 of the crumpler 301.

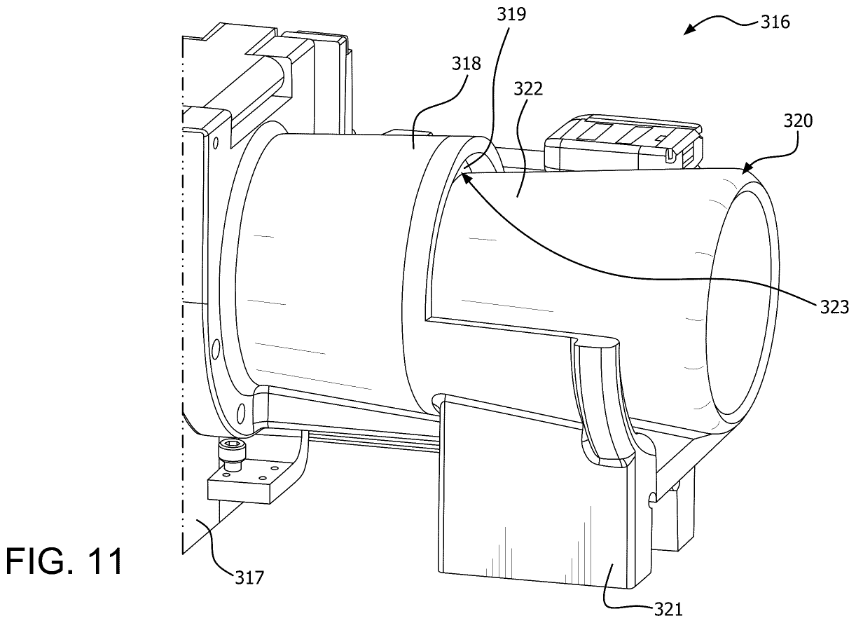

FIG. 11 depicts another alternative embodiment of the former 20 in the form of a former 316. The former 315 is depicted as being fixed to a crumpler 317 similar to the crumpler 22, and is supported by a support member 321.

The former 316 has an outer former 318 and an inner former 320 fixed to the outer former 318. The upper half of the outer former 308 does not extend the full length of the outer former 318. More specifically, the upper half of the outer former 318 extends from the forward or downstream end of the outer former 318 and ends about halfway along the length of the outer former 318, so that the stock material 14 can be wrapped around a body 322 of the inner former 320 as discussed above in relation to the former 20. The body 322 is substantially similar structurally and functionally to the body 44 of the inner former 40. FIG. 11 also depicts a channel 323 between an interior surface 319 of the outer former 308 and an outer surface of the body 322 of the inner former 320.

In other alternative embodiments in which the inner former remains stationary in relation to the outer former, the axial length, or upstream-downstream dimension of the upstream portion of the inner former can be increased so that an upstream end portion of the inner former remains outside of the outer former, with the length of the upstream end portion being sufficient to permit the operator to wrap the stock material 14 around the upstream end portion and push the wrapped stock material 14 into the forming area or channel between the inner former and the outer former.

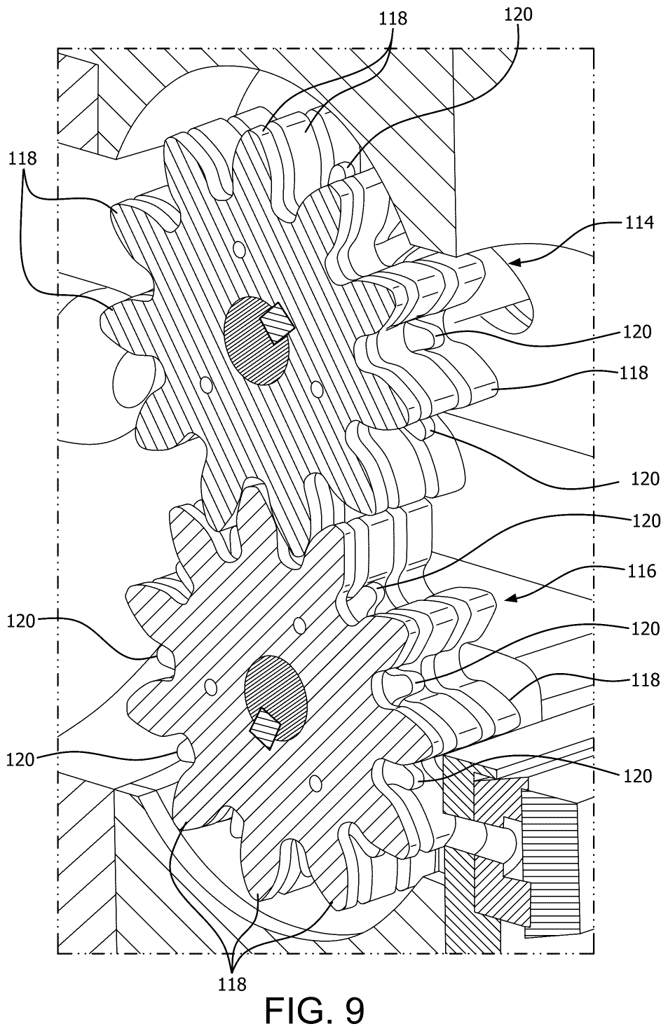

The crumpler 22 comprises compression members that form the stock material 14 into its final configuration as the dunnage 12. The compression members can be configured, for example, as an upper forming roller 114 and a lower forming roller 116. The upper and lower forming rollers 114, 116 are shown in FIG. 9. As discussed below, the upper and lower forming rollers 114, 116 receive the stock material 14 from the former 20 in a pre-formed state suitable for being entrained by the upper and lower forming rollers 114, 116 and converted to the dunnage 12. The crumpler 22 also includes a housing 85 and a cover 86. The housing 85 is mounted on the frame 58 directly downstream of the outer former 42 of the former 20 and is connected to the outer former 42.

The cover 86 is coupled to the outer former 42 of the former 20 so that the cover 86 can be rotated in relation to the housing 85 and the outer former 42 between a closed position shown in FIG. 4, and an open position shown in FIGS. 1 and 2. For example, the cover 86 can be coupled to the outer former 44 by partially-hidden friction hinges 87 that restrain the cover 86 in its open position. The cover 86 can rotate by about 90° when moving between its open and closed positions, so that the cover 86 can be moved out of the way when needed so as to facilitate clearance of jams of the stock material 14 in the crumpler 22, and service of the upper and lower forming rollers 114, 116 and other internal components of the crumpler 22. The cover 86 can be secured in its closed position by latches 88 that are mounted on the cover 86 and engage the housing 85 via recesses 90 or other suitable features on the housing 85.

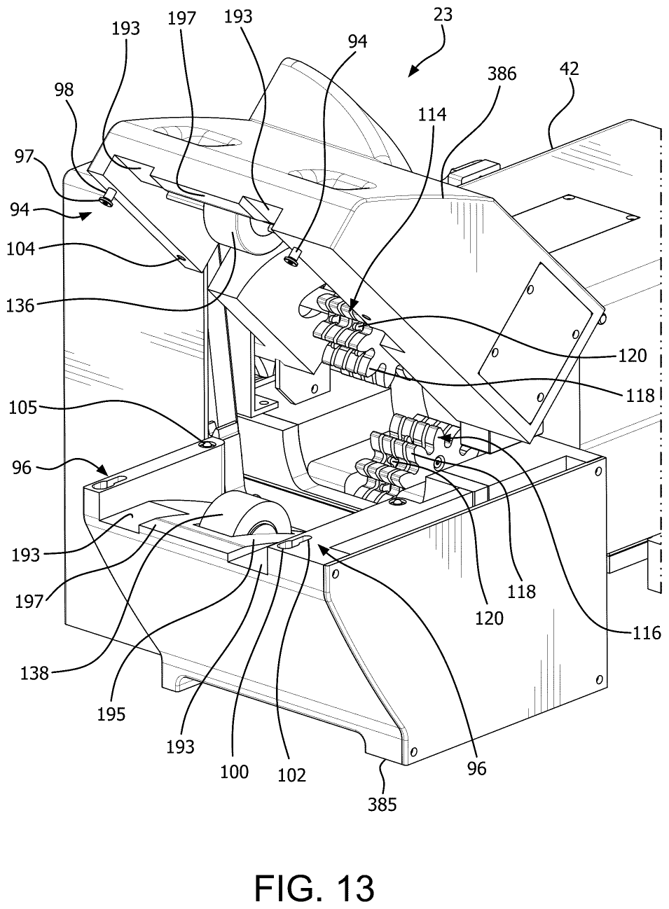

FIGS. 13-15 depict an alternative embodiment of the crumpler 22 in the form of a crumpler 23. The crumpler 23 includes a housing 385 and a cover 386. The cover 386 is coupled to the outer former 42 by a hinge 92 that facilitates rotation of the cover 386 in relation to the housing 385 and the outer former 42, while permitting a limited amount of linear movement of the cover 386 in relation to the housing 385 and the outer former 42. The cover 386 is secured in its closed position by two shoulder bolts 94 that are mounted on the cover 386 and engage the housing 385 by way of respective keyed slots 96 formed in the housing 385. Each shoulder bolt 94 has a head 97, a smooth shoulder 98 that adjoins the head, and a threaded portion (not shown) that adjoins the shoulder 98. The threaded portion of each shoulder bolt 94 engages the cover 386 by way of a corresponding threaded hole formed in the cover 386.

Each keyed slot 96 includes a relatively large end portion 100 having a diameter that is slightly larger than the maximum width of the head 97 of the shoulder bolt 94, so that the head 97 can pass through the end portion 100 as the cover 386 is rotated to its closed position. Each slot 96 also has a slotted portion 102 that adjoins the end portion 100. The slotted portion 102 has a width that is slightly larger than the width of the shoulder 98 of the shoulder bolt 94, but less than the maximum diameter of the head 97 of the shoulder bolt 94. The head 97 of each shoulder bolt 94 passes through the end portion 100 of the corresponding keyed slot 96 as the cover 386 is moved to its closed position while the head 97 is aligned with the end portion 100. Once the head 97 has passed through the end portion 100 and has entered a recessed area in the cover 386 directly below the slot 96, the cover 386 can be moved linearly, in the rearward or upstream direction, so that the shoulder 98 of each shoulder bolt 94 becomes disposed in the slotted portion 102 of the slot 96.

The crumpler 22 can include spring-loaded ball detents 104 mounted on the housing 385 and configured to engage associated recesses 105 formed in the cover 386 as the cover 386 is moved rearward, to discourage the cover 386 from moving forward once the shoulders 98 of the shoulder bolts 94 have moved fully rearward within the respective slots 96.

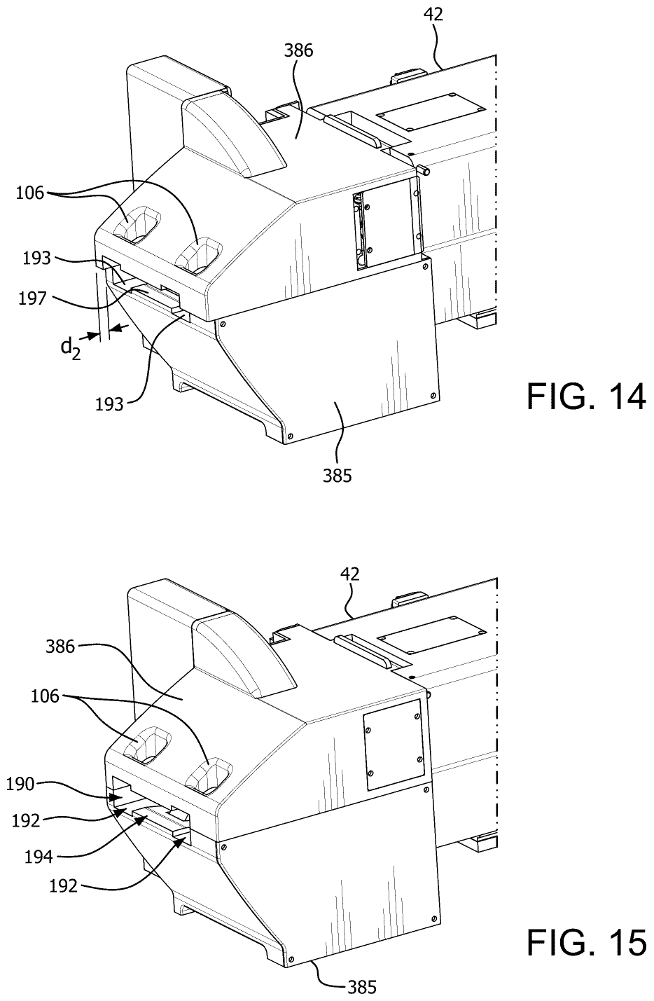

To move the cover 386 to its open position shown in FIG. 15, user can pull the cover 386 forward with sufficient force to overcome the resistance of the spring detents 104 and move the cover 386 slightly forward, by the distance “d₂” denoted in FIG. 14, so as to align the head 97 of each shoulder bolt 94 with the end portion 100 of the corresponding keyed slot 96, so that the head can pass through the keyed slot 96 by way of the end portion 100 as the cover 386 is rotated away from its closed position shown in FIG. 13. The cover 386 can include grooves 106 that accommodate the fingers of the user and thereby assist the user in pulling the cover 386 in the forward direction. In alternative embodiments, the shoulder bolts 94 can be mounted on the housing 85a, and the keyed slots 96 can be formed in the cover 386.

As can be seen in FIGS. 2 and 3, the lower forming roller 116 is mounted in the housing 85 of the crumpler 22. The crumpler 22 further includes an actuator in the form of, for example, an electric drive motor 108. The drive motor 108 is mounted in the housing 85 and is coupled to the lower forming roller 116 by a shaft 110 that extends through the lower forming roller 116 so that the drive motor 108 drives the shaft 110 and the attached lower forming roller 116 in rotation in relation to the housing 85. The upper forming roller 114 is mounted in the cover 86. The upper forming roller 114 is idle, i.e., is not driven directly by a motor. The upper forming roller 114 is driven by the lower forming roller 116 and is configured to mesh with the lower forming roller 116 when the cover 86 is in its closed position.

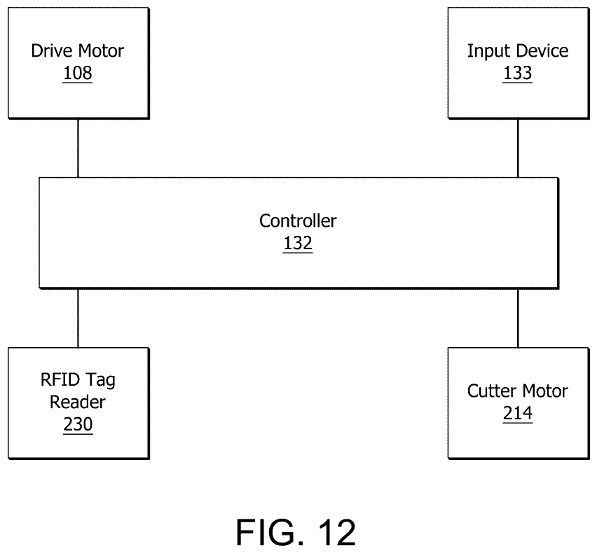

The crumpler 22 further comprises a controller 132. The drive motor 108 is communicatively coupled to the controller 132 and is activated in response to an input from the controller 132. The input from the controller 132 to the drive motor 108 can be initiated, for example, by the operator when a piece of dunnage 12 is needed. The operator can provide an input to the controller 132 by way of a suitable input device 133 such as a keypad, a touch screen, a hand or foot-operated switch, etc. The controller 12 and the input device 133 are depicted in FIG. 12. Alternatively, or in addition, the controller 132 can be configured to produce the pieces of dunnage 12 on an automated basis.

The controller 132 comprises a processor, such as a microprocessor; an internal bus; a memory communicatively coupled to the processor via the bus; computer-executable instructions stored in the memory; and an input-output interface communicatively coupled to the internal bus. The computer-executable instructions, upon being executed by the processor, cause the controller 132 to perform the logical operations disclosed herein. The controller 132 can include components in addition to, or in lieu of those disclosed herein, a description of which is not necessary to an understanding of the disclosed technology.

The stock material 14 reaches the upper and lower forming rollers 114, 116 in a folded configuration due to the passage of the stock material through the former 20. As noted above, the operator initially wraps the leading end of the stock material 14 around the body 44 of the inner former 40. The stock material 14 then can be pushed in the forward, or downstream direction by the operator, into the passage 64 of the outer former 42, so that the leading edge of the stock material 14 is located downstream of the leading, or downstream ends of the rods 56 and becomes crammed against or otherwise contacts the upper and lower forming rollers 114, 116 when the inner former 40 is moved to its closed position with the stock material wrapped around the body 44 and following the inner former 40. The leading end of the stock material 14 thus becomes entrained between the forming rollers 114, 116 when the crumpler 22 is activated and the forming rollers 114, 116 begin to rotate. Once the leading end of the stock material 14 has been entrained by the forming rollers 114, 116, continued rotation of the forming rollers 114, 116 causes the stock material 14 to be drawn from the supply unit 18 or other material source, over the forming surface 77 of the inlet 70, and into and through the forming area or channel 63 between interior surface 62 of the outer former 42 and the outer surface 55 of the body 44 of the inner former 40, as can be seen in FIG. 4.

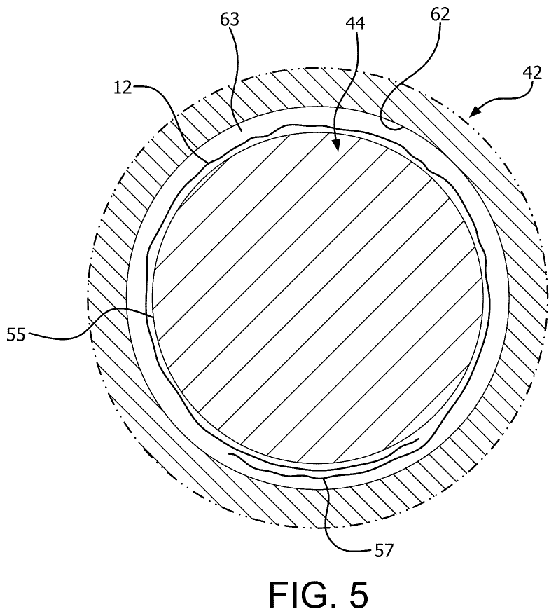

As noted above, the movement of the web of stock material 14 over the forming surface 77 of the inlet 70 provides initial breakage of the flat web into a curved shape, and centers the web. The interior surface 62 of the outer former 42 and the outer surface 55 of the body 44 of the inner former 40 subsequently shape the stock material 14 as it passes over the body 44. Due the curvilinear configuration of the outer surface 55 of the body 44, the stock material already has begun bending at the point it reaches the outer former 42. The curvilinear interior surface 65 of the outer former 42, in combination with the decreasing diameter of the passage 64 in the downstream direction, cause the stock material 14 to progressively bend over and onto itself as the stock material 14 is drawn through the inner former 40, so that the side edges and the adjacent portions of the stock material overlap and begin to form layers of the stock material 14 as shown in FIG. 5. The body 44 of the inner former 40 can provide support to the bending stock material 14 and can help maintain the tubular shape of the stock material 14, preventing the stock material 14 from collapsing onto itself in response to the inwardly-directed force exerted on the stock material 14 by the outer former 42. (The outer former 42 is depicted diagrammatically in FIGS. 5-7.)

The stock material 14 begins contacting the rods 56 after passing over the body 44. As can be seen in FIG. 6, the rods 56 are offset from the centerline of the passage 64 and are not aligned with the upper and lower forming rollers 114, 116, i.e., the upper and lower forming rollers 114, 116 are not located directly downstream of the rods 56. The rods 56 thus support the outer, or side portions of the folded stock material 14 as shown in FIG. 6, and maintain the width, or transverse dimension of the folded stock material 14 as the folded stock material 14 passes over the downstream end of the body 44 and over the rods 56. The rods 56 thus spread the folded stock material 14 and prevent the stock material 14 collapsing or contracting inward, toward the centerline of the passage 64, while permitting the layers of the tubular stock material 14 to partially collapse vertically onto each other in the central portion of the stock material. The rods 56 thus allow the central portion of the folded stock material to become entrained between the upper and lower forming rollers 114, 116 after the stock material 14 has passed over the rods 56, while helping to prevent entrainment of the side portions the stock material 14. The rods 56 thus support the outer, or side portions of the stock material 14, and help to prevent the side portions from collapsing as the central portion of the stock material 14 becomes entrained between and crimped by the upper and lower forming rollers 114, 116 after the stock material 14 has passed over the rods 56. The rods 56 thus maintain the interior dimensions of the tube into which the stock material 14 was shaped by the former 20. The rods 56 prevent the tube from collapsing inward, toward the centerline of the passage 64. The rods 56 also prevent the side portions of the tube from collapsing vertically as the upper and lower forming rollers 114, 116 compress the central portion of the stock material 14 into the spine 24 of the dunnage 12, allowing the lobes 26 of the dunnage 12 to be formed adjacent to the spine 24.

FIG. 7 depicts the stock material 14 as it passes between and is deformed by the upper and lower forming rollers 114, 116. As noted above, the outer former 42 has bent the stock material so as to produce overlapping layers 57 of the stock material 14. The forming rollers 114, 116 each include a plurality of relatively large forming teeth 118, shown in detail in FIG. 9. The forming teeth 118 of the driven lower forming roller 116 mesh with the forming teeth 118 of the idle upper forming roller 114 so the upper and lower forming rollers 114, 116 pull the stock material 14 into the crumpler 22, and compress or crimp the overlapping layers 57 of the stock material 14 into each other along the central portion of the stock material 14 as shown in FIG. 7, thereby forming the spine 24 of the dunnage 12. The dunnage 12 is depicted in FIG. 8.

Each of the upper and lower forming rollers 114, 116 also includes a plurality of relatively small stitching teeth 120, also shown in detail in FIG. 9. The stitching teeth 120 are located in the valleys between the forming teeth 118. The relative positions of the stitching teeth 120 on the upper and lower forming rollers 114, 116 are staggered so that the stitching teeth 120 of the respective upper and lower forming rollers 114, 116 do not interfere with each other. The stitching teeth 120 are configured to puncture the various layers 57 of the central portion of the stock material 14 that has been compressed or crimped by the forming teeth 118 into the spine 24 of the dunnage 12. The punctures in the overlying layers act as a type of stich that helps to hold the layers to each other and discourage “unzippering” of the spine 24.

As can be seen in FIG. 7, the lateral ends or side portions of the stock material 14 are offset from the upper and lower forming rollers 114, 116 and are supported by the rods 56, and therefore are not compressed by the upper and lower forming rollers 114, 116. These portions of the stock material 14 form the lobes 26 of the dunnage 12. Because the lobes 26 have not been compressed, the lobes 26 have a relatively low density and a relatively high loft that allows the dunnage 12 to provide a protective cushioning effect, for example, when placed in a shipping container along with a packaged item.

Referring to FIGS. 1, 2, and 12, the crumpler 22 includes a safety switch that prevents activation of the upper and lower forming rollers 114, 116 when the cover 86 of the crumpler 22 is in its open position. The safety switch can be, for example, a magnetic switch 126 comprising a receiver 128 and a magnet 130. The magnet 130 is mounted on the cover 86. The receiver 128 is mounted on the forward portion 82 of the guide 48 of the former 20, so that the receiver 128 moves with the inner former 40 in the upstream and downstream directions as the inner former 40 is moved between its open and closed positions.

The receiver 128 is aligned with, and is adjacent to the magnet 130 when the cover 86 and the inner former 40 both are in their respective closed positions. The receiver 128 is not aligned with, and is not adjacent to the magnet 130 when one or both of the cover 86 and the inner former 40 are not in their respective closed positions, as can be seen in FIGS. 1 and 2.

The receiver 128 and the drive motor 108 that drives the lower forming rollers 116 are communicatively coupled to the controller 132. The receiver 128 generates an output in response to the magnetic field of the magnet 130 only when the receiver 128 is aligned with, and adjacent to the magnet 130. The controller 132 is configured to allow activation the drive motor 108 only when the controller 132 is receiving the output of the receiver 128 indicating that the receiver 128 is aligned with, and adjacent to the magnet 130. Thus, the upper and lower forming rollers 114, 116 can be driven only when the cover 86 and the inner former 40 are in their respective closed positions. This feature can help reduce the potential for operator injury caused by inadvertent contact with the forming rollers 114, 116 or the cutting mechanism 134 of the crumpler 22. In alternative embodiments, the receiver 128 can be mounted on the cover 86, and the magnet 130 can be mounted on the forward portion 82 of the guide 48 of the former 20. In other alternative embodiments, a switch other than the magnetic switch 126 can be used as the safety switch.

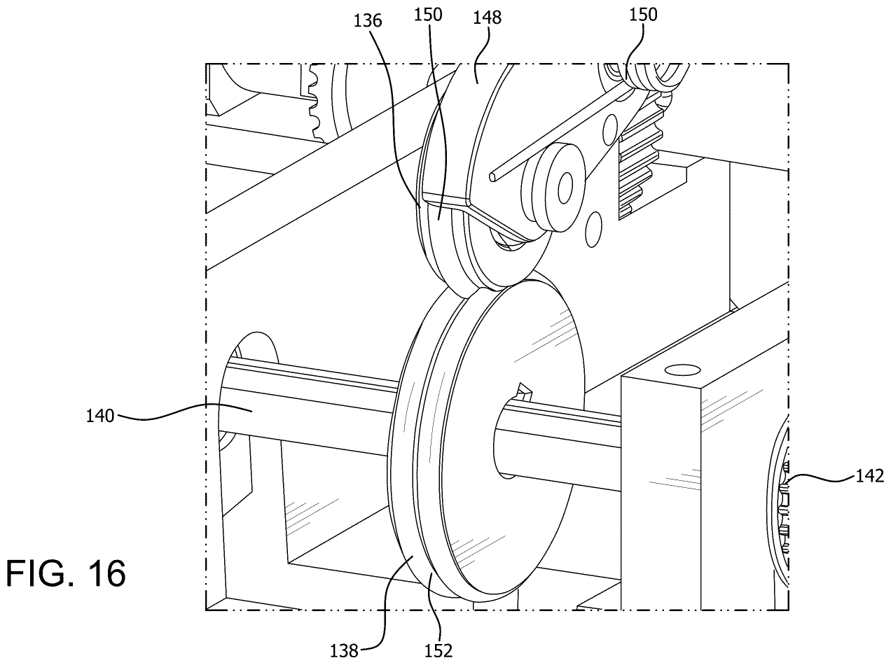

Referring to FIG. 16, the crumpler 22 also includes an upper eject, or outfeed roller 136; and a lower eject, or outfeed roller 138. The upper and lower outfeed rollers 136, 138 pull the fully formed dunnage 12 after it has passed through the upper and lower forming rollers 114, 116, and eject the dunnage 12 through an exit opening 190 defined by the housing 85 and the cover 86 of the crumpler 22. The upper and lower outfeed rollers 136, 138 are configured to ride along the spine 24 of the dunnage 12. The lower outfeed roller 138 is mounted in the housing 85. The upper outfeed roller 136 is mounted in the cover 86 of the crumpler 22. The upper and lower outfeed rollers 136, 138 can be formed from an elastomeric material, to help increase friction between the upper and lower outfeed rollers 136, 138 and the dunnage 12.

The lower outfeed roller 138 can be driven by the drive motor 108 that drives the upper and lower forming rollers 114, 116. In particular, the lower outfeed roller 138 is mounted on a shaft 140, and a first pulley 142 is mounted on an end of the shaft 140. A second pulley 144 is mounted on an end of the shaft 110 on which the lower forming roller 116 is mounted. The first and second pulleys 142, 144 are connected by way of a belt 146, so that the rotation of the second pulley 144 in response to the rotation of the shaft 110 by the drive motor 108 is imparted to the first pulley 142, and the associated shaft 140 and lower outfeed roller 138, by way of the belt 146. The rotational speed of the lower outfeed roller 138 can be set by the pulley ratio of the first and second pulleys 142, 144. For example, the pulley ratio can be selected so that the lower outfeed roller 138 can be overdriven, i.e., rotated at a higher rotational speed than the lower forming roller 116, so that tension is maintained in the dunnage 12 as the dunnage 12 is pulled by upper and lower outfeed rollers 136, 138 after leaving the upper and lower forming rollers 114, 116.

The upper outfeed roller 136 is idle, i.e., is not driven directly by a motor. The upper outfeed roller 136 is mounted on, and is configured to rotate in relation to a mount 148. The mount 148 is connected to the cover 86 so that the mount 148 can pivot in relation to the cover 86. The crumpler 22 includes a torsion spring 149 configured to exert a downward force on the mount 148. The downward force urges the mount 148, and the upper outfeed roller 136, toward the lower outfeed roller 138.

During operation, the spine 24 of the dunnage 12 produced by the upper and lower forming rollers 114, 116 passes between the upper and lower outfeed rollers 136, 138. The friction between the upper outfeed roller 136 and the dunnage 12 resulting from the downward bias of the mount 148, in conjunction with the movement of the dunnage 12 past the upper outfeed roller 136, cause the upper outfeed roller 136 to rotate. Also, the upper outfeed roller 136 resists upward movement of the spine 24, so that the spine 24 is squeezed between the upper and lower outfeed rollers 136, 138. The dunnage 12 is ejected from the crumpler 22 by way of the exit opening 190 due to the motive force provided by the lower outfeed roller 138.

The upper outfeed roller 136 can have a ridge or raised portion 150 formed along the outer periphery thereof, and the lower outfeed roller 138 can have a recess 152 formed therein and extending along the outer periphery of the lower outfeed roller 138. The recess 152 is configured to receive the raised portion 150, so as to increase the pinching force, and the resulting friction, exerted on the dunnage 12 by the upper and lower outfeed rollers 136, 138. Also, the upper and lower outfeed rollers 136, 138 can be formed from an elastomeric material, to further increase the friction between the upper and lower outfeed rollers 136, 138 and the dunnage 12.

Alternative embodiments of the crumpler 22 can be equipped with a dedicated actuator in the form of, for example, an electric drive motor, to drive the upper and lower outfeed rollers 136, 138, in lieu of the belt-driven arrangement described above.

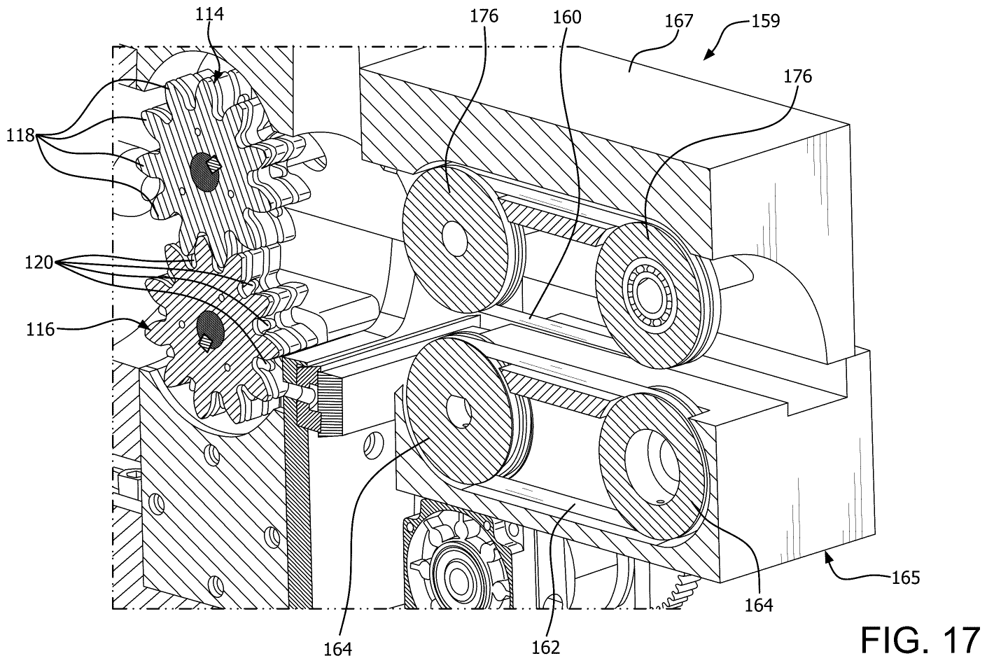

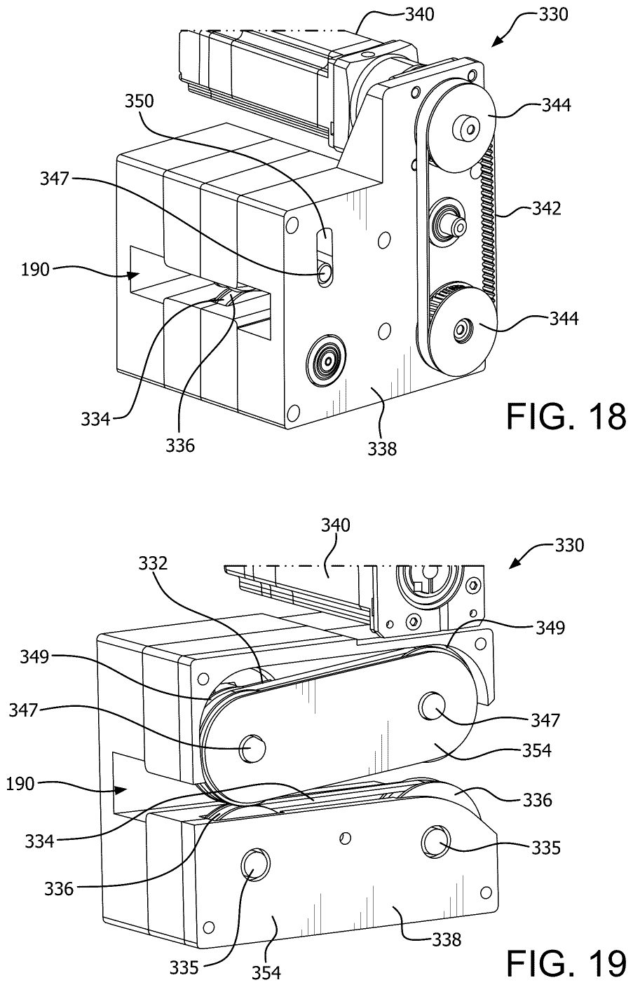

FIG. 17 depicts an alternative embodiment of the crumpler 22 in the form of a crumpler 158 comprising a belt drive unit 159 in lieu of the upper and lower outfeed rollers 136, 138. The belt drive unit 159 facilitates the use of a relatively large exit opening without the danger that the user's fingers may come in contact with the upper and lower forming rollers 114, 116, because the length of the belt drive unit 159 is sufficient to reduce or eliminate the possibility that the user's fingers could reach the upper and lower forming rollers 114, 116 is inserted through the exit opening. The relatively large exit opening can accommodate pieces of dunnage 12 having a relatively large cross-sectional area.

The belt drive unit 159 includes an upper belt 160 and a lower belt 162 configured to drive and eject the dunnage 12. The upper and lower belts 160, 162 can be configured, for example, as O-rings. Alternatively, the upper and lower belts 160, 162 can be conventional single-sided or double-sided drive belts.

The lower belt 162 is mounted on two lower pulleys 164 mounted for rotation on a housing 165 of the crumpler 158. One of the lower pulleys 164 is driven by a drive motor (not shown). The upper belt 160 is mounted on two upper pulleys 176 mounted for rotation on a cover 167 of the crumpler 158. The upper pulleys 178 are not driven directly by a motor or other type of actuator.

During operation, the dunnage 12 produced by the upper and lower forming rollers 114, 116 becomes disposed between the upper and lower belts 160, 162. The friction between the upper belt 160 and the dunnage 12 in conjunction with the downstream movement of the dunnage 12, causes the upper outfeed roller 136 to rotate. Also, the upper pulleys 176 resist upward movement of the dunnage 12, so that the dunnage 12 is squeezed between the upper and lower belts 160, 162 and is ejected from the crumpler 158 by way of the exit opening due to the motive force provided by the lower belt 162.

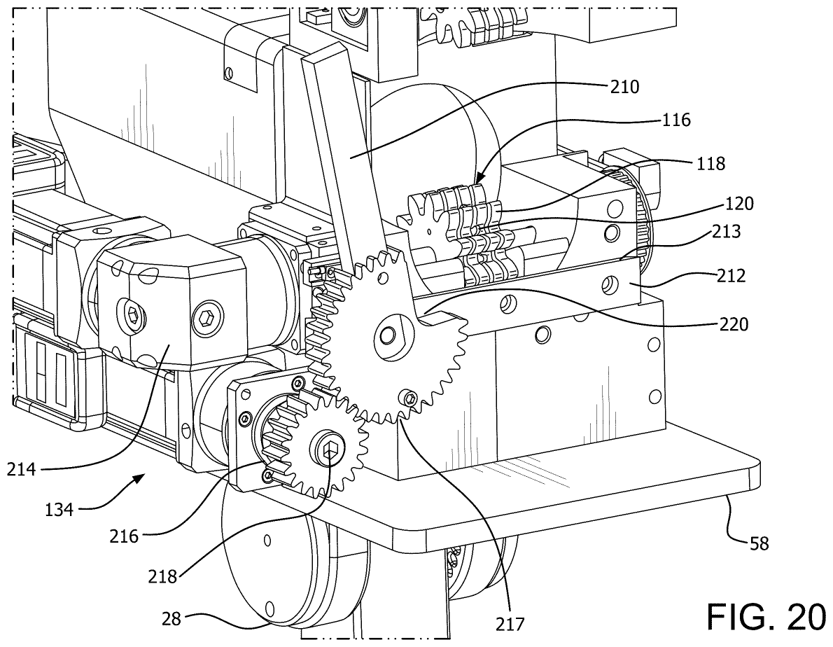

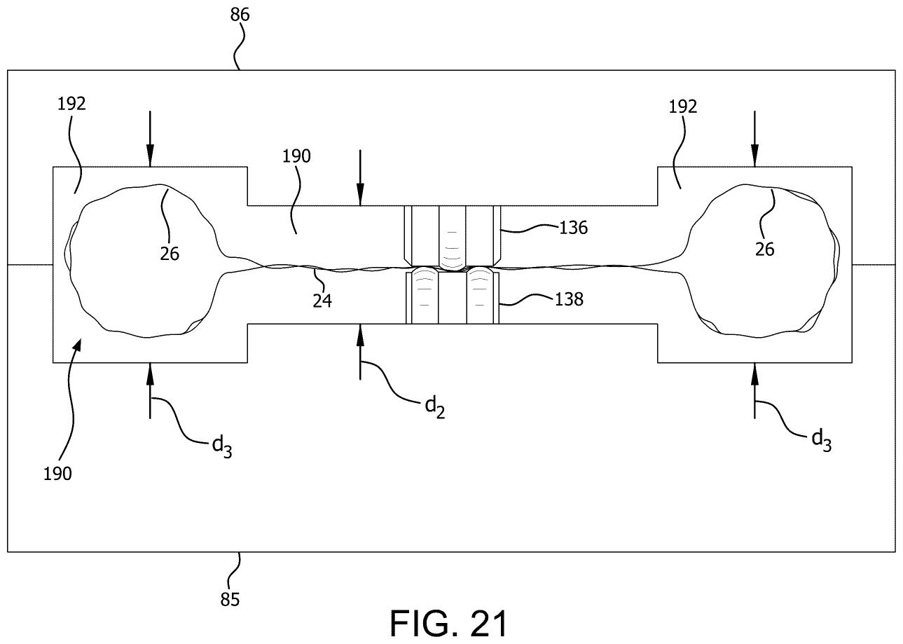

FIGS. 19 and 20 depict an alternative embodiment of the belt drive unit 159 in the form of a belt drive unit 330. The belt drive unit 330 includes an upper belt 332 and a lower belt 334 configured to drive and eject the dunnage 12. The upper and lower belts 332, 334 can be configured, for example, as O-rings. Alternatively, the upper and lower belts 332, 334 can be conventional single-sided or double-sided drive belts.

The lower belt 334 is mounted on two lower pulleys 336. Each lower pulley 336 is mounted on a respective shaft 335. The shafts 335 are mounted for rotation within a housing 338. One of the lower pulleys 336 is driven by a drive motor 340, via a drive belt 342 and two drive pulleys 344.

The upper belt 332 is mounted on two upper pulleys 349 mounted for rotation on the housing 338. Each upper pulley 349 is mounted on a respective shaft 347. The shafts 347 are mounted for rotation within the housing 338. The upper pulleys 349 are not driven directly by a motor or other type of actuator.

The downstream shaft 347 is positioned in a vertical slot 350 formed in the housing 338, so that the downstream upper pully 349 can undergo a limited amount of vertical movement in relation to the housing 338. Also, the downstream shaft 347, and the attached upper pulley 349, are biased downward by a spring (not shown). Guards 354 are positioned on both sides of the upper pulleys 349 to reduce the potential for the fingers of the operator to contact the upper pulleys 349 or the upper belt 332 by way of the slot 350.

During operation, the dunnage 12 produced by the upper and lower forming rollers 114, 116 becomes disposed between the upper and lower belts 332, 334. The friction between the upper belt 332 and the dunnage 12 resulting from the downward bias of the downstream upper pully 349, in conjunction with the downstream movement of the dunnage 12, causes the upper belt 332 to rotate. Also, the upper pulleys 349 resist upward movement of the dunnage 12, so that the dunnage 12 is squeezed between the upper and lower belts 332, 334 and ejected from the crumpler by way of the exit opening 190 due to the motive force provided by the lower belt 334.

As noted above, the dunnage 12 exits the crumpler 22 by way of the exit opening 190 defined by the housing 85 and the cover 86 of the crumpler 22. The exit opening 190 is sized and shaped to reduce the potential for the fingers of the operator to contact the upper and lower outfeed rollers 136, 138 (or the upper or lower belts 160, 162). The exit opening 190 includes two side portions 192, and a center portion 194.

Referring to FIG. 13, each side portion 192 is defined, in part, by a flat surface 193 on the housing 85 and another flat surface 193 on the cover 86, with the surfaces 193 defining the respective top and bottom of each side portion 192. The center portion 194 is defined by a flat surface 197 on the housing 85 and another flat surface 197 on the cover 86, with the surfaces 197 defining the respective top and bottom of the center portion 194. Also, the housing 85 and the cover 86 each have an angled surface or ramp 195 that is located upstream of, and adjoins the surfaces 193 and the surface 197. As can be seen in FIG. 13, the portions of the ramps 195 directly upstream of the surfaces 193 are shorter than the portions of the ramps 195 directly upstream of the surface 197.

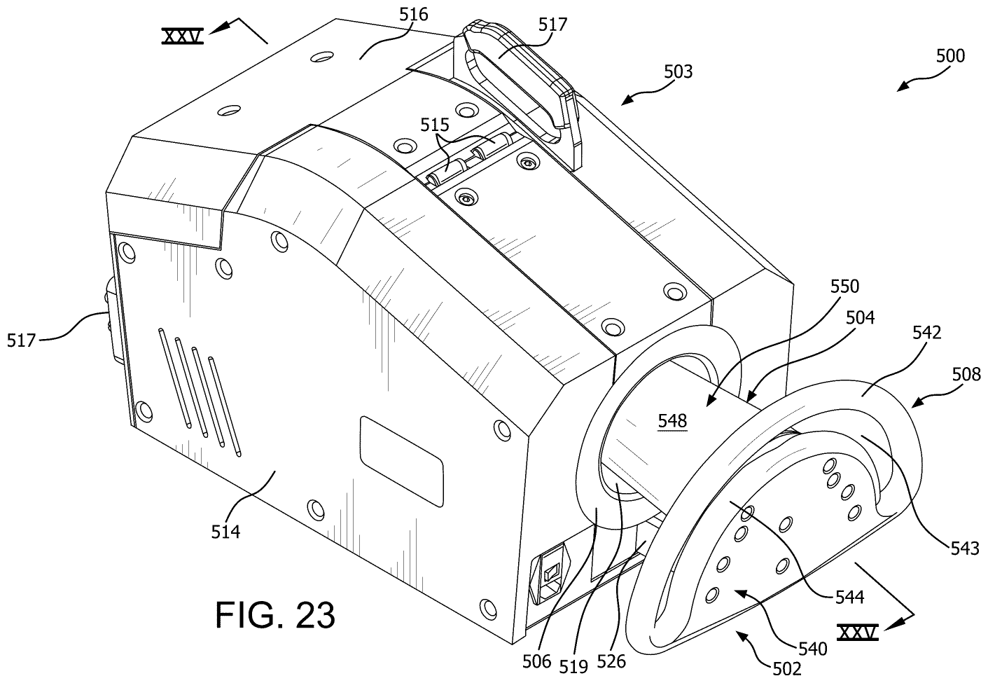

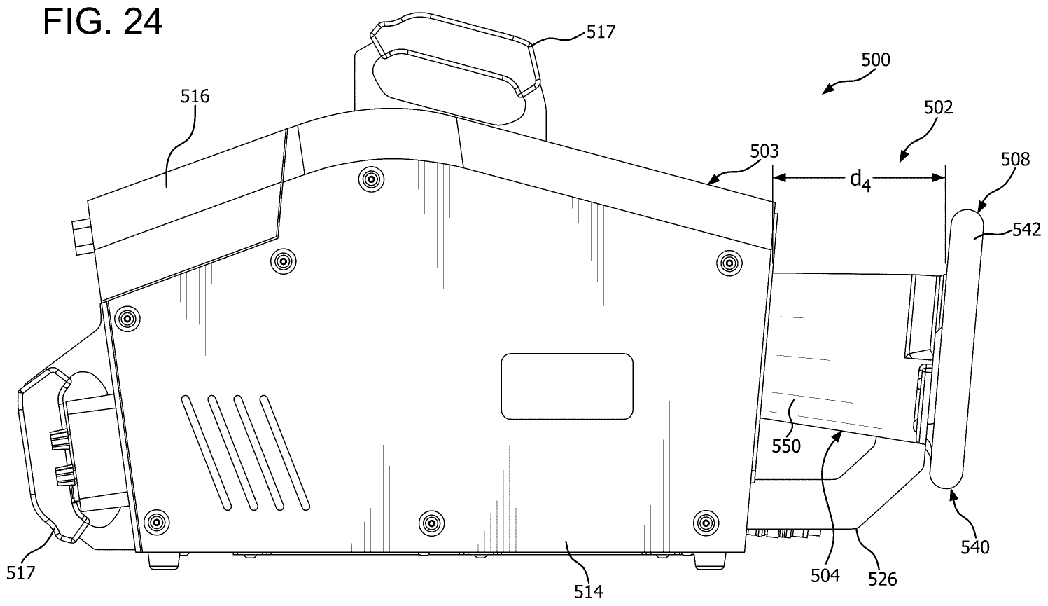

The center portion 194 of the exit opening 190 is aligned with, i.e., is located directly downstream of, the upper and lower outfeed rollers 136, 138 and is configured to reduce the potential for the fingers of the operator to contact the outfeed rollers 136, 138. In particular, the center portion 194 has a height, or vertical dimension, that is selected such that the fingers of an average human cannot pass through the center portion to reach the outfeed rollers 136, 138. The height of the center portion 194 is denoted by the reference character “d₂” in FIG. 23. For example, the height of the center portion 194 can be about 20 mm. The lateral dimensions of the exit opening 190 can be selected such that the center portion 194 extends outward, by about 30 mm, from the sides of the upper and lower outfeed rollers 136, 138 from the perspective of FIG. 23, i.e., each side of the center portion 194 is laterally misaligned by about 30 mm, from the perspective of FIG. 23, with a respective side of the outfeed rollers 136, 138. Thus, the overall width, or lateral dimension, of the center portion 194 can be about 70 mm when the width of the outfeed rollers 136, 138 is equal to about 10 mm. These dimensions permit the relatively short spine 24 of the dunnage 12 to pass freely through the center portion 194, while preventing the fingers of an average human from being inserted through the exit opening 190 such that the operator's fingers can come into contact with the outfeed rollers 136, 138.

The height and width of the side portions 192 each can be about 30 mm. The height of the center portion 192 is denoted by the reference character “d₃” in FIG. 23. These dimensions permit the relatively large lobes 26 of the dunnage 12 to pass through the side portions 192.

The above-noted dimensions for the side and center portions 192, 194 are presented for illustrative purposes only. The side and center portions 192, 194 can be dimensioned as needed to accommodate the dimensions of a particular type of dunnage 12.

Referring to FIG. 20, the cutting mechanism 134 of the crumpler 22 comprises a blade 210, an anvil 212 having a shearing surface 213, and an actuator in the form of, for example, an electric motor 214. The blade 210 is coupled to the motor 214 by way of a drive gear 216 mounted on the motor 214, and a blade gear 217 on which the blade 210 is mounted. The blade gear 217 is configured to mesh with the drive gear 216, so that the torque generated by the motor 214 is transferred to the blade 210 by way of the drive gear 216 and the blade gear 217, causing the blade 210 to rotate. The blade 210 is configured to rotate from a home or stowed position shown in FIG. 20, to a cutting position (not shown). The blade 210 can rotate by, for example, about 105° when translating between its stowed and cutting positions.

The blade 210 and the anvil 212 are positioned downstream of the upper and lower forming rollers 114, 116, and upstream of the upper and lower outfeed rollers 136, 138 when the blade 210 is in the cutting position. The blade 210 rotates into a position proximate, and adjacent to the anvil 212 as the blade 210 reaches the cutting position, so that the dunnage 12 is restrained from downward movement by the anvil 212 as the blade 210 moves downwardly to, along with the shearing surface 213, sever the dunnage 12.

The drive gear 216 has a hexagonally-shaped recess 218 formed in the end thereof. The recess 218 can receive a similarly-shaped key to facilitate manual rotation of the drive gear 216. This feature can be used, for example, to manually return the blade 210 to its stowed position when the crumpler 22 is jammed (and the cover 86 is raised so as to prevent inadvertent activation of the upper and lower forming rollers 114, 116 as discussed above).

A cutout 220 is formed in the blade gear 217. The cutout aligns 220 with the material path of the dunnage 12 when the blade 210 is in its stowed position, so that the blade gear 217 does not interfere with the advancement of the dunnage 12 past the cutting mechanism 134.

The upstream side of the blade gear 217 has a recess formed therein and configured to receive an end portion of the blade 210, so that the blade 210 is keyed to the blade gear 217. The blade 210 is fixed to the blade gear 217 by a suitable means such as screws. The blade gear 217, and the attached blade 210, can be mounted on the anvil 212, for example, by a fastener that extends through a through hole formed in the center of the blade gear 217. The fastener 224 can engage the anvil 212 via a threaded bore formed in the anvil 212, and threads formed on an end portion of the fastener 224. A thrust bearing and a spring washer (not shown) can be disposed between the blade gear 217 and the head of the fastener 224, so that the blade gear 217, and the attached blade 210, can rotate in relation to the fastener 224 (and the anvil 212) as fastener 224 exerts a force on the blade 210 that retains the blade 210, and the attached blade gear 217, on the anvil 212.

Alternative embodiments of the crumpler 22 can have a cutting mechanism other than the cutting mechanism 134. For example, the cutting mechanisms of alternative embodiments can be configured to cut dunnage 12 using a wire, a laser, a knife, a guillotine, etc.

The crumpler 22 also can include an RFID tag reader 230 communicatively coupled to the controller 132, as depicted in FIG. 12. The RFID tag reader 230 be mounted on the housing 85, and can provide the controller 132 with an indication of the presence of the stock material 14 in the crumpler 22 when the stock material 14 is equipped with RFID tags.

FIGS. 23-26 depict an alternative embodiment of the device 16 in the form of a device 500 for producing dunnage, such as the dunnage 12, from a stock material such as the stock material 14. The device 500 includes a former 502, and a crumpler 503. The device 500 can be configured to rest directly on a supporting surface (not shown), such as the upper surface of a workstation at which items are packaged. Alternatively, the device 500 can be mounted on and supported by a support, such as the support 28 discussed above in relation to the device 16.

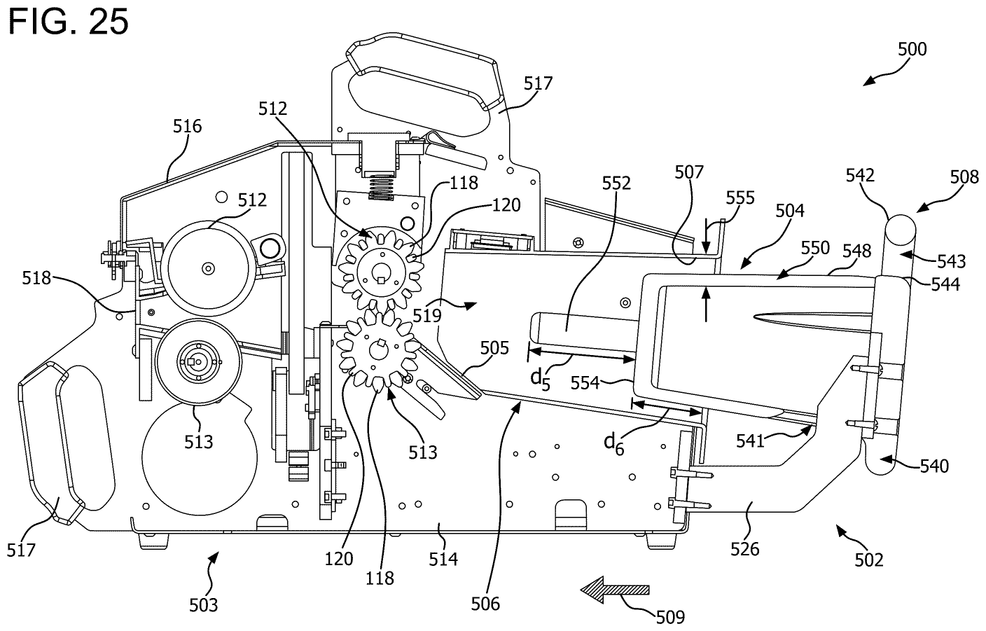

The former 502 is configured to direct the stock material 14 to the crumpler 503 in a forward, or downstream direction, while folding the stock material 14 into a shape that makes the stock material suitable 14 for being fed into the crumpler 503, as discussed above in relation to the device 16. The crumpler 503 converts the stock material 14 into the lower density dunnage 12 described above. The forward or downstream direction is denoted in FIG. 25 by the arrow 509.

The crumpler 503 is substantially similar to the crumpler 22 of the device 16, and the above description of the crumpler 22 applies equally to the crumpler 503 unless otherwise noted.

Referring to FIG. 25, the crumpler 503 includes an upper forming roller 114 and a lower forming roller 116 that form the stock material 14 into its final configuration as the dunnage 12. The upper and lower forming rollers 520, 522 are substantially similar to the respective upper and lower forming rollers 114, 116 of the crumpler 22, and the above description of the upper and lower forming rollers 114, 116 applies equally the respective upper and lower forming rollers 512, 513. As discussed above in relation to the crumpler 503, the upper and lower forming rollers 512, 513 receive the stock material 14 from the former 502 in a pre-formed state suitable for being entrained by the upper and lower forming rollers 512, 513 and converted into the dunnage 12.

The crumpler 503 also includes a housing 514, and a cover 516. The cover 516 is coupled to the housing 514 so that the cover 516 can be rotated in relation to the housing 514 between a closed position shown in FIGS. 23-25, and an open position (not shown), as discussed above in relation to the cover 86 of the crumpler 22. For example, the cover 516 can be coupled to the housing 514 by friction hinges 515 that restrain the cover 516 in its open position. The cover 516 can rotate by about 90° when moving between its open and closed positions, so that the cover 516 can be moved out of the way when needed so as to facilitate clearance of jams of the stock material 14 in the crumpler 503, and service of the upper and lower forming rollers 512, 513 and other internal components of the crumpler 22.

The housing 514 can include handles 517 that facilitate carrying the device 500 and moving the device 500 along its supporting surface. The handles 517 are depicted in FIGS. 23-25.

Referring to FIG. 25, the crumpler 503 also includes an upper eject, or outfeed roller 520; and a lower eject, or outfeed roller 522. The upper and lower outfeed rollers 520, 522 are substantially similar to the respective upper and lower outfeed rollers 136, 138 of the crumpler 22, and the above description of the upper and lower outfeed rollers 136, 138 applies equally the respective upper and lower outfeed rollers 520, 522. The upper and lower outfeed rollers 520, 522 are configured to ride along the spine 24 of the dunnage 12. The upper and lower outfeed rollers 520, 522 are further configured to pull the fully-formed dunnage 12 after it has passed through the upper and lower forming rollers 512, 513, and to eject the dunnage 12 through an exit opening 518 defined by the housing 514 and the cover 516 of the crumpler 503, as discussed above in relation to the crumpler 22.

The former 502 includes an inner former 504, an outer former 506, and an inlet 508. The inner former 504 is fixed in relation to the outer former 506 and is partially disposed within a passage 519 defined by an interior surface 507 the outer former 506. The inlet 508 is fixed to a rearward or upstream end of the inner former 504.

Referring to FIG. 25, the outer former 506 is fixed to the housing 514 of the crumpler 503 using fasteners of other suitable techniques. The passage 519 defined by the outer former 520 decreases in diameter in the forward or downstream direction, as discussed above in relation to the outer former 42 of the former 20. A downstream end of the outer former 506 can have an angled portion 505, to help guide the stock material 14 between the upper and lower forming rollers 512, 513.

The inlet 508 is substantially similar to the inlet 70 of the former 20 of the device 16, and the above description of the inlet 70 applies equally to the inlet 508 unless otherwise noted.

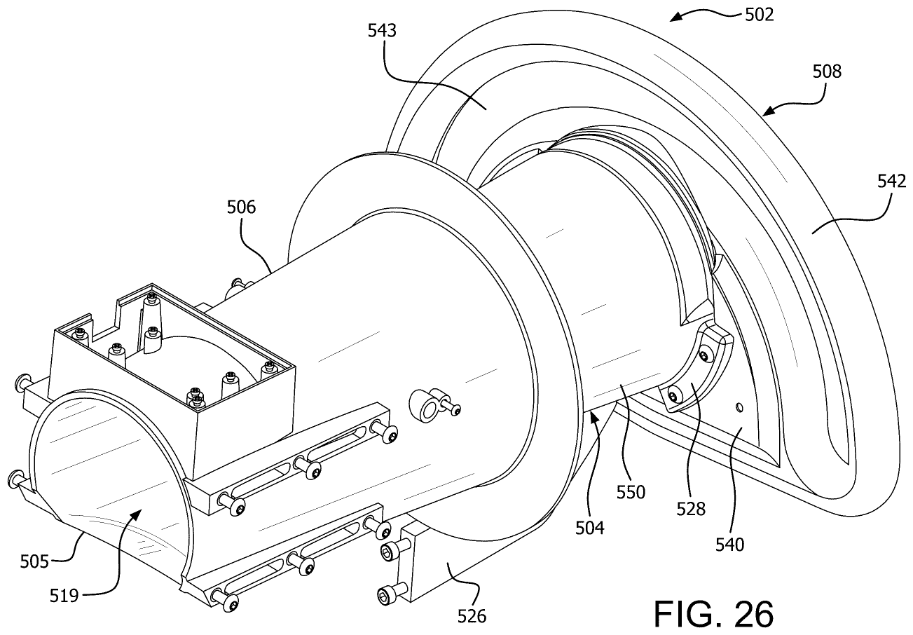

Referring to FIGS. 23 and 26, the inlet 508 has a body 540, and an upper guide or upper member 542 that is connected to and extends over the body 540. The upper member 542 can be configured as a continuous curved bar that extends through an arc of about 180 degrees, with the respective ends of the upper member 542 adjoining the body 540. The upper member 542 can have other configurations in alternative embodiments. For example, the upper member 542 can be discontinuous in alternative embodiments. In one such embodiment, the upper member 542 can be formed from two relatively short curved bars that extend from opposite sides of the body 540 and do not meet.

The upper member 542 has a circular cross section, as can be seen in FIG. 25. The upper member 542 can have a cross section other than circular in alternative embodiments.

The body 540 has a rounded forming surface 544, visible in FIG. 23. The forming surface 544 is spaced from the upper member 542 by a channel 543. As discussed above in relation to the inlet 70, the stock material 14 is drawn over the forming surface 544 and through the channel 543 as the stock material 14 is drawn into the former 502. The forming surface 544 provides initial breakage of the flat web of stock material 14 into a curved shape, folding the side portions downward in relation to the longitudinal centerline of the web. Also, the forming surface can center the web of stock material 14 if the stack or roll from which the web is being drawn is misaligned with the former 502. In addition, the forming surface 544 can turn, or change the general path of the web of stock material 14 by, for example, about 45 degrees to about 135 degrees, depending on the relative orientations of the crumpler 503 and the supply unit 18.

The inlet 508 can be configured to accommodate stock material 14 having a width, or side-to-side dimension, of about 15 inches. In alternative embodiments, the forming surface 544 of the body 540 can have a scalloped or undulating shape along its length that further helps to gather the stock material 14 inward, to help the former 502 accommodate stock materials having a relative large width, such as 30 inches. The use of 15-inch wide and 30-inch wide stock material is referred to for illustrative purposes only. The crumpler 503 can be used with stock materials having other widths, including widths less than 15 inches and greater than 30 inches.

As noted above in relation to the device 16, the device 500 can be used to convert stock material 14 provided, for example, as webs of fan-folded sheets or rolled sheets. The sheets can be fan folded or rolled in single layers. In other embodiments, the multiple layers of sheets can be fan folded or rolled together such that the dunnage 12 produced by the device 500 is made of superimposed sheets that are crumpled together in the conversion process. In such multi-layer applications, the superimposed sheets can have the same basis weight, or different basis weights. In some applications, the superimposed sheets can be adhered to each other by, for example, adhesive. The adhesive can be applied, for example, as a strip of adhesive running down the middle of one or both of the sheets.

In some applications, the stock material 14 can be embossed sheets of material, which can result in greater loft in the dunnage 12 produced by the device 500.

The inner former 504 is similar to the inner former 40 of the former 20, and the above description of the inner former 40 applies equally to the inner former 504 unless otherwise noted. The inner former 504 includes a body 550. The inner former 504 also includes a spreader in the form of, for example, two rods 552. As can be seen in FIG. 25, the rods 552 are mounted on a forward, or downstream wall 554 of the body 550, and extend from the downstream wall 554 in a downstream direction. As discussed above in relation to the inner former 40, the rods 552 can be configured, for example, as rods having a circular cross section.

The inner former 504 is configured so that a forward or upstream portion of the body 550 is disposed within a rearward or upstream end of the passage 519 within the outer former 508, as shown in FIG. 25. The body 550 is sized so that the local diameter of the portion of the body 550 disposed in the passage 519 is less than the local diameter of the passage 519. A channel 555 thus is formed between an outer surface 548 of the body 550 and the adjacent interior surface 507 of the outer former 506, as can be seen in FIG. 25. In some applications, the inner and outer formers 504, 506 can be sized so that the channel 555 is sufficient to permit the stock material 14 to pass between the inner and outer formers 504, 506 as the stock material 14 is pulled through the former 502 by the upper and lower forming rollers 512, 513, but small enough to prevent the fingers of the operator from coming into contact with the upper and lower forming rollers 512, 513 by way of the channel 555. In such applications, the channel 555 can be considered a curved slot for the purpose of determining the safety distance to hazard.

The inlet 508 is mounted on a bracket 526, as can be seen in FIG. 25. A rearward or upstream end of the inlet 508 can be fixed to the bracket 526 by fasteners that engage the body 540 of the inlet 508. The inlet 508 can be fixed to the bracket 526 using other suitable techniques in the alternative. The downstream end of the bracket 526 can be fixed to an upstream end of the housing 514 using fasteners or other suitable techniques. The inlet 508 thus is supported from the upstream end of the housing 514 in a cantilevered arrangement.

The upstream end of the inner former 504 is fixed directly to the body 540 of the inlet 508 using fasteners that engage flanges 528 on the inner former 504, as can be seen in FIG. 26. The inner former 504 can be fixed to the body 540 using other techniques in the alternative. The inner former 504 thus is supported from the inlet 508 in a cantilevered arrangement, and does not directly contact the outer former 506. In alternative embodiments, the inner former 504 can be fixed directly to the housing 514. For example, in one such embodiment, the bracket 526 can be connected directly to the inner former 504, and the inlet 508 can be suspended from the inner former 504. In other alternative embodiments, the inner former 504 can be connected to the inlet 508 by an intermediate member, such as a bracket or spacer, so that the inner former 504 is spaced from the inlet 508. In other alternative embodiments, the inner former 504 and the inlet 508 can be connected separately to the housing 514.

Referring to FIG. 25, the bracket 526 can extend though a slot 541 formed in the bottom of the body 550 of the inner former 504, at and near the upstream end of the body 550. As can be seen in FIG. 25, the top of the inner former 504 is aligned with the forming surface 544 of the body 540 of the inlet 508, so that the stock material 14 can pass directly onto the outer surface 548 of the body 550 of the inner former upon leaving the forming surface 544.

As can be seen in FIGS. 24 and 25, a portion of the body 550 is located outside, and upstream of the passage 519 within the outer former 506, leaving that portion of the body 550 exposed, and accessible from the exterior of the crumpler 503. The length of the exposed portion of the body 550 is denoted in FIG. 24 by the reference character “d₄.” The length d₄ can be sufficient to permit operators to fit one or both of their hands between the housing 514 and the inlet 508 while wrapping the stock material 14 around the outer surface 548 of the body 550 and feeding the stock material 14 downstream to engage the upper and lower forming rollers 512, 513. For example, in some embodiments, the length d₄ can be about five inches or greater. The length d₄ can be less than five inches in other embodiments.

The length of the portion of the body 550 located within the passage 519 is denoted in FIG. 25 by the reference character “d₆.” In some embodiments, the length d₆ can be, for example, about 2.5 inches. In other embodiments, the length de can be greater, or less than 2.5 inches.

Because the bracket 526 passes through the bottom of the body 550 of the inner former 504, the stock material 14 can be wrapped around the entire top half of the exposed portion of the body 550. Also, because the bracket 526 passes through the upstream end of the body 550, the stock material 14 can be wrapped around the entire outer circumference of the portion of the body 550 located between the bracket 526 and the outer former 506. Thus, the side portions of the stock material 14 can meet and overlap before the stock material 14 enters the passage 519 within the outer former 506, which in turn helps to place the stock material 14 in an optimal configuration for subsequently being converted into the dunnage 12 by the upper and lower forming roller 512, 513 as discussed above in relation to the crumpler 22.

The stock material 14 reaches the upper and lower forming rollers 512, 513 in a tubular configuration due to the passage of the stock material through the former 502. As noted above, the operator initially wraps the leading end of the stock material 14 around the outer surface 548 of the body 550 of the inner former 504. Also, the operator pushes the stock material 14 in the forward, or downstream direction, into the passage 519 defied by the outer former 506, so that the leading edge of the stock material 14 is located downstream of the leading, or downstream ends of the rods 552 and becomes crammed against or otherwise comes into contact with the upper and lower forming rollers 512, 513. The leading end of the stock material 14 thus becomes entrained between the upper and lower forming rollers 512, 513 when the crumpler 503 is activated and the upper and lower forming rollers 512, 513 begin to rotate. Once the leading end of the stock material 14 has been entrained by the upper and lower forming rollers 512, 513, continued rotation of the upper and lower forming rollers 512, 513 causes the stock material 14 to be drawn from the supply unit 18 (or other material source), over the forming surface 544 of the inlet 508, and into and through the channel 555 between the interior surface 507 of the outer former 506 and the outer surface 548 of the body 550 of the inner former 504.

As noted above, the movement of the web of stock material 14 over the forming surface 544 of the inlet 508 provides initial breakage of the flat web into a downwardly-curved shape, and centers the web. Also, the forming surface 544 can turn, or change the general path of the web by an obtuse angle, for example, by about 45 degrees to about 135 degrees, depending on the orientation of the crumpler 503. The forming surface 544 bends the stock material 14 in a direction of a material path of the stock material while bending side edge portions of the stock material 14 about a longitudinal centerline of the stock material 14 as the stock material is drawn over the forming surface 544. In some embodiments, the forming surface 544 is U-shaped and imparts a U-shaped bend to the stock material 14 as it bends the side edge portions of the stock material 14 downward with respect to the longitudinal centerline of the stock material 14, and toward the former 502.

The interior surface 507 of the outer former 506 and the outer surface 548 of the body 550 of the inner former 504 subsequently shape the stock material 14 as it passes over the body 550. Due the curvilinear configuration of the outer surface 548 of the body 550, the stock material 14 already has begun folding at the point it reaches the inner former 504. The curvilinear interior surface 507 of the outer former 506, in combination with the decreasing diameter of the passage 519 in the downstream direction, cause the stock material 14 to progressively fold over and onto itself as the stock material 14 is drawn over the inner former 504, so that the side portions of the stock material 14 overlap and begin to form layers of the stock material 14. The body 550 of the inner former 504 provides support to the folding stock material 14 and maintains the tubular shape of the stock material 14, preventing the stock material 14 from collapsing onto itself.

As also discussed in relation to the crumpler 22, the stock material 14 begins contacting the rods 552 after passing over the body 550. The abrupt change in height between the body 550 and the rods 552 permits the height, or vertical dimension of the stock material 14 to drop substantially before the stock material 14 is crimped by the upper and lower forming rollers 512, 513, while the spaced-apart rods 552 maintain the width of the stock material 14. In particular, the rods 56 are offset from the centerline of the passage 519 and are not aligned with the upper and lower forming rollers 512, 513, i.e., the upper and lower forming rollers 512, 513 are not located directly downstream of the rods 552. The rods 552 thus support the outer, or side portions of the stock material 14, and help to prevent the side portions from collapsing as the central portion of the stock material 14 becomes entrained between and crimped by the upper and lower forming rollers 512, 513 after the stock material 14 has passed over the rods 552. The rods 552 thus maintain the interior dimensions of the tube into which the stock material 14 was shaped by the former 502. The rods 552 prevent the tube from collapsing inward, toward the centerline of the passage 519. The rods 552 also prevent the side portions of the tube from collapsing vertically as the upper and lower forming rollers 512, 513 compress the central portion of the stock material 14 into the spine 24 of the dunnage 12, allowing the lobes 26 of the dunnage 12 to be formed adjacent to the spine 24.

The downstream wall 554 of the inner former 504 adjoins the outer surface 548 of the body 550 at an angle slightly above 90 degrees, as can be seen in FIG. 25, which can result in an abrupt change in the height of the stock material 14 as the stock material 14 passes from the body 550 to the rods 552. In alternative embodiments, the downstream end of the body 550 can have an angled configuration, with the downstream wall 554 adjoining the outer surface 548 at an angle greater than 90 degrees, to produce a more gradual reduction in the height of the stock material is it passes from the body 550 to the rods 552.

The length of the rods 552 can affect the characteristics of the dunnage 12 produced by the device 500. The optimal length of the rods 552 is application-dependent, and can vary with factors such as the type of material being used as the stock material 14, the basis weight of the stock material 14, whether the stock material 14 is supplied as a single layer or in multiple layers, etc. For example, in some applications, the rods 552 can have a minimum length of about 3.5 inches. In other applications, the rods 552 can have a length of, for example, about 3.5 inches to about 12 inches. The length of the rods 552 is denoted in FIG. 25 by the reference character “d₅.”

The optimal spacing between the rods 552 and the upper and lower forming roller 512, 513 likewise is application-dependent, and can vary with factors such as the type of material being used as the stock material 14, the basis weight of the stock material 14, whether the stock material 14 is supplied as a single layer or in multiple layers, etc. The spacing between the rods 552 and the upper and lower forming roller 512, 513 should be large enough to avoid tearing of the stock material 14 as the stock material 14 is drawn between the rods 552 and the upper and lower forming roller 512, 513, but small enough to avoid the folded stock material 14 from losing loft before reaching the upper and lower forming rollers 512, 513. As shown in FIG. 25, the spacing between the downstream ends of the rods 552 and the upper and lower forming rollers 512, 513 is slightly greater than the length d₅ of the rods 552. In alternative embodiments, the spacing between the downstream ends of the rods 552 and the upper and lower forming rollers 512, 513 can be less than, or greater than that shown in FIG. 25.

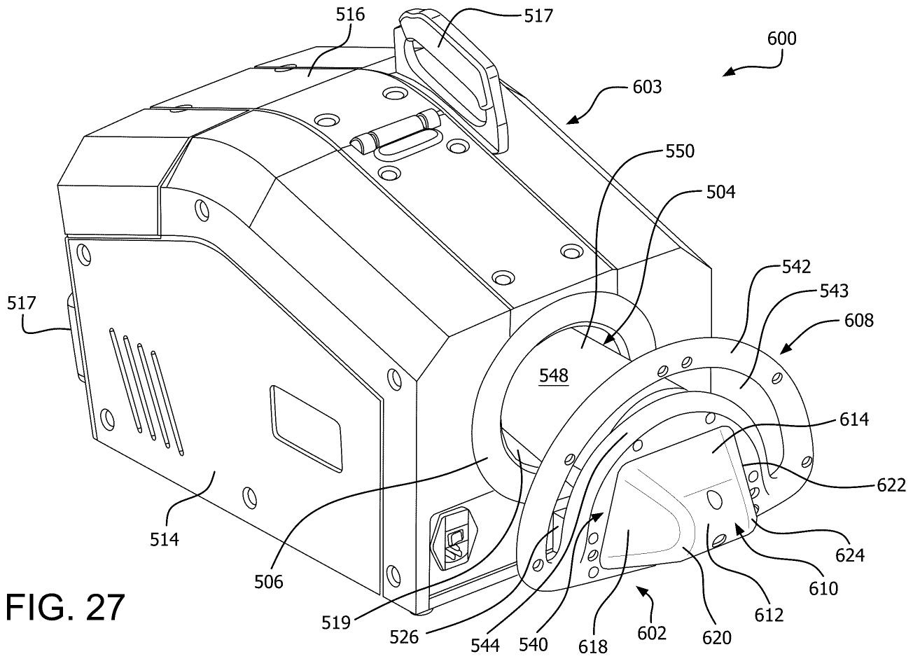

FIGS. 27-29 depict an alternative embodiment of the device 500 in the form of a device 600 for producing dunnage, such as the dunnage 12, from a stock material such as the stock material 14. The device 600 includes a former 602, and a crumpler 603. The crumpler 603 is substantially identical to the crumpler 503, and the above description of the crumpler 503 applies equally to the crumpler 603. The former 602 is substantially identical to the former 502 with the following exceptions, and unless otherwise noted, the above description of the former 502 applies equally to the former 602. Components of the device 600 that are the same as or substantially similar to those of the device 500 are referred to by identical reference numbers.

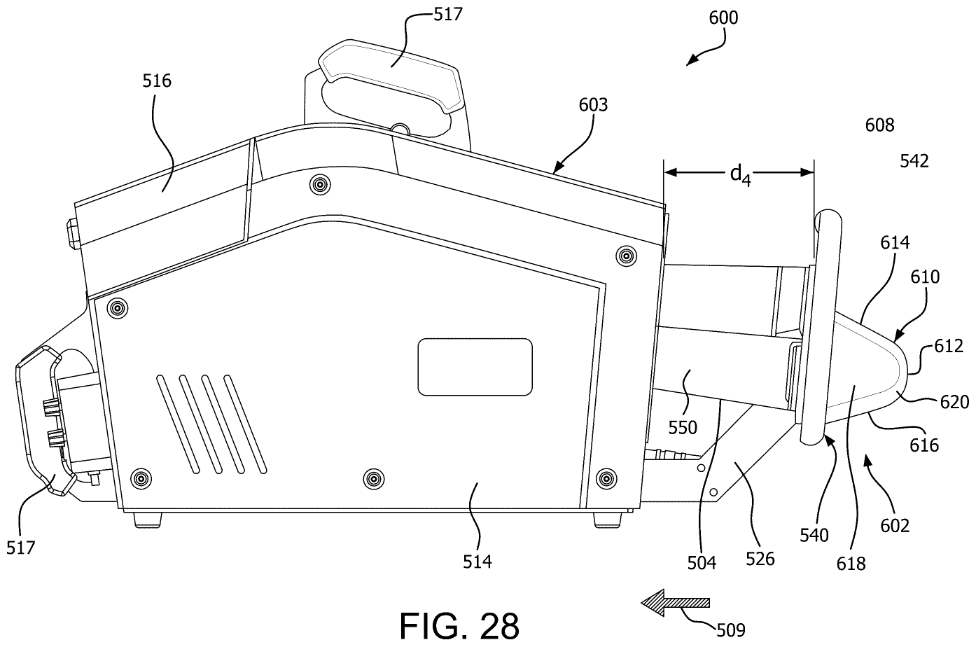

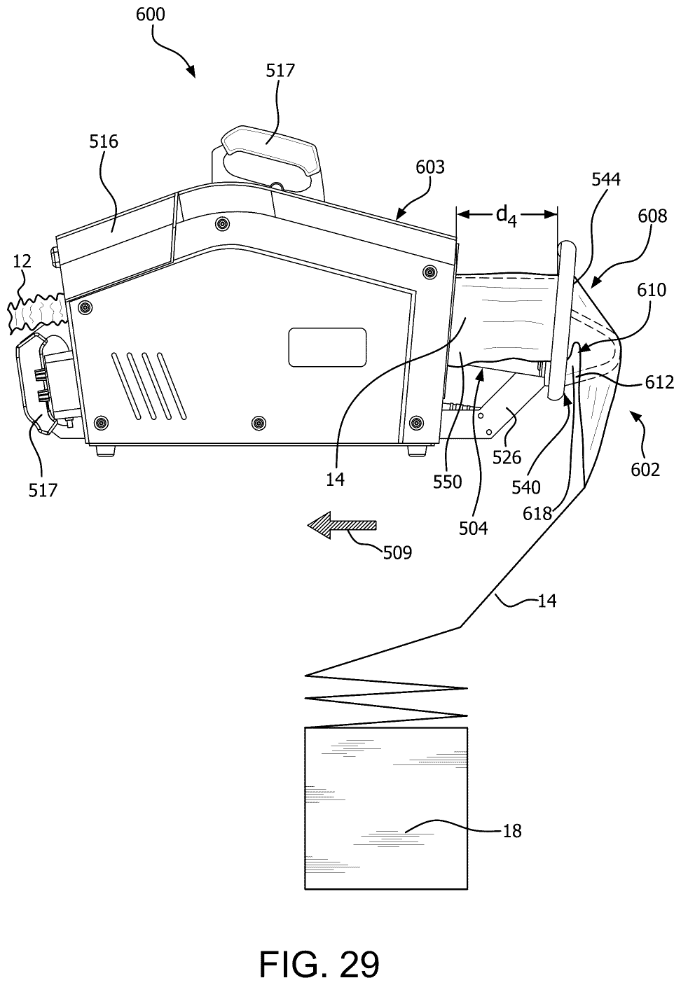

The inlet 608 includes a forming member 610. The forming member 610 is fixed to an upstream side of the body 540, using fasteners of other suitable techniques. The forming member 610 and the body 540 can be formed integrally in alternative embodiments. The forming member 610 projects from the body 540 in the upstream direction and is configured to turn and fold the stock material 14 before the stock material reaches the forming surface 544 of the body 540. The downstream direction is denoted in FIGS. 28 and 29 by the arrow 509.

The forming member 610 is symmetrically disposed about the longitudinal centerline of the former 602 with respect to the transverse, or side to side direction and the vertical direction.

The forming member 610 includes an upstream surface 612. The upstream surface 612 is rounded, as viewed from the perspective of FIG. 28, extends transversely across the body 540, and is symmetrically disposed about a transverse axis extending through the vertical midpoint of the projection.

The forming member 610 also includes an upper surface 614 and a lower surface 616 that adjoin respective upper and lower ends of the upstream surface 612. The upper surface 614 and the lower surface 616 are substantially planar. The upper surface 614 is angled upwardly with respect to the downstream direction, and the lower surface 616 is angled downwardly with respect to the downstream direction, as can be seen in FIG. 28.

The forming member 610 also includes a side surface 618, and a rounded transition surface 620. The transition surface 620 adjoins the side surface 618, the upper and lower surfaces 614, 616, and the upstream surface 612. The forming member 610 also includes a side surface 622, and a rounded transition surface 624. The transition surface 624 adjoins the side surface 622, the upper and lower surfaces 614, 616, and the upstream surface 612. The side surfaces 618, 622 are substantially planar, and are symmetrically disposed about a vertical axis extending through the transverse mid-point of the forming member 610. The side surfaces 618, 622 are angled outwardly with respect to the downstream direction as can be seen in FIG. 27.

FIG. 29 depicts the stock material 14 being drawn into and through the former 602 from a fan-folded stack of the stock material 14. The stock material 14 initially contacts the forming member 610, and is drawn around the upstream surface 612 of the forming member 610 so that the stock material 14 is turned so as to reach the forming surface 544 of the body 540 in an angled orientation in relation to the downstream direction. For example, in some embodiments, the stock material 14 can have an orientation between about 70 degrees and about 20 degrees when reaching the forming surface 544. In some embodiments, the stock material 14 can have an orientation between about 60 degrees and about 30 degrees when reaching the forming surface 544. In some embodiments, the stock material 14 can have an orientation of about 45 degrees when reaching the forming surface 544.

Also, the angled orientation of the side surfaces 618, 622 cause the side portions of the stock material 14 to be drawn around the forming member 610 and folded in the downstream direction in relation to the longitudinal centerline of the stock material. This folding, in conjunction with the bending of the stock material 14 around the rounded upstream surface 612 of the forming member 610, breaks the stock material from its initial planar state so that the stock material 14 reaches the forming surface 544 of the body 540 in a partially folded configuration. The forming surface 544 imparts further folding to the stock material 14 so that the stock material reaches the body 550 of the inner former 504 with a smooth, downward curvilinear fold about the longitudinal centerline of the stock material 14.

The breaking of the sheet material 14 from a planar configuration to a partially-folded configuration by the forming member 610, and the restraint on upward movement of the stock material 14 provided by the upper member 542 of the body 540 help the stock material 14 to move smoothly and uniformly through the former 602, which in turn facilitates operation at high feed rates with minimal jamming. For example, in some embodiments, the device 600 can convert 15-inch wide sheets of stock material 14 at a feed rate of about 65 inches per second.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A device for producing dunnage from a stock material, comprising:
a former, including:
an outer former having an interior surface defining a passage configured to receive the inner former, the interior surface configured to bend the stock material into overlapping layers as the stock material moves through the passage in a downstream direction with respect to a material path of the stock material, and
an inner former having an outer surface, at least a portion of the outer surface opposing and being spaced from the interior surface of the outer former so that the outer surface and the interior surface of the outer former define a channel configured to receive the stock material; and
a crumpler positioned downstream of the former with respect to the material path and configured to compress the overlapping layers of the stock material, wherein:
the passage has a depth corresponding to a maximum dimension of the passage in a first direction, the first direction coinciding with a radial direction within a radial plane about a centerline of the passage, the radial direction intersecting a transverse centerline of the stock material within the passage;
the passage has a width equal to a maximum dimension of the passage in a second direction perpendicular to the first direction and the centerline of the passage;
the passage has an aspect ratio defined by the width of the passage to the depth of the passage, the aspect ratio being about 1.7:1 or less along the length of the passage.

2. The device of claim 1, wherein:
the inner surface of the outer former defines a cross-sectional perimeter of the passage; and
the cross-sectional perimeter of the passage is curved along more than 50 percent of the cross-sectional perimeter.

3. The device of claim 2, wherein a cross-sectional perimeter of the passage is generally circular or oval.

4. The device of claim 2, wherein a cross-sectional perimeter of the passage is free of concavities over a distance of more than 1/10 of a transverse dimension of the stock material.

5. The device of claim 1, wherein the inner former has a frusto-conical configuration.

6. The device of claim 1, wherein the inner former has a circular transverse cross section or an oval transverse cross section.

7. The device of claim 1, wherein the passage tapers inward toward the centerline of the passage in the downstream direction over more than 50 percent of a length of the passage.

8. The device of claim 1, further including a spreader positioned downstream of the inner former with respect to the material path, wherein:
the interior surface configured to bend the stock material into the overlapping layers to form a tube of the stock material, and
the spreader is configured to maintain interior dimensions of the tube.

9. The device of claim 1, further comprising an inlet located upstream of the former with respect to the material path and having a forming surface configured to bend the stock material in a direction of the material path while bending side edge portions of the stock material about a longitudinal centerline of the stock material as the stock material is drawn over the forming surface.

10. The device of claim 1, wherein the inner former is fixed in relation to the outer former.

11. The device of claim 10, wherein a portion of the inner former extends upstream from an upstream end of the passage to an extent that permits the stock material to be inserted into the channel by pushing the stock material along the outer surface of the inner former.

12. The device of claim 10, wherein a portion of the inner former extends upstream from an upstream end of the passage to an extent that permits the stock material to be wrapped around the inner former.

13. The device of claim 1, wherein the inner former is telescopically disposed in relation to the outer former so that the inner former can at least partially withdraw from the passage.

14. The device of claim 1, wherein the crumpler includes compression elements configured to compress and puncture the overlapping layers of the stock material along a central portion of the stock material to form the dunnage having a central portion and two lobes adjoining opposite sides of the central portion the dunnage and having a greater loft that the central portion of the dunnage.

15. The device of claim 14, wherein the crumpler further includes:
a housing; and
a cover mounted on the housing and configured to move between an open and closed position in relation to the housing, the compression elements being mounted in the housing and/or the cover, wherein:
the housing and/or the cover define an exit opening configured to allow the dunnage to exit the crumpler, and
the exit opening includes a central portion aligned with the compression elements with respect to the material path, and two lateral portions offset from the compression elements with respect to the material path.

16. The device of claim 15, wherein:
the central portion of the exit opening is configured to facilitate passage of the central portion of the dunnage through the exit opening; and
the lateral portions of the exit opening are configured to facilitate passage of the respective lobes of the dunnage material through the exit opening.

17. The device of claim 16, further comprising a cutting mechanism located downstream of the compression members and having a cutter element configured to server the dunnage, wherein the central portion of the exit opening is aligned with the cutter element with respect to the material path.

18. The device of claim 17, wherein the central portion of the exit opening is sized to prevent fingers from accessing an interior of the crumpler.

19. A device for producing dunnage from a stock material, comprising:
a former, including:
an outer former having an interior surface defining a passage configured to receive the inner former, the interior surface configured to bend the stock material into overlapping layers as the stock material moves through the passage in a downstream direction with respect to a material path of the stock material to form a tube of the stock material, and
an inner former having an outer surface, at least a portion of the outer surface opposing and being spaced from the interior surface of the outer former so that the outer surface and the interior surface of the outer former define a channel configured to receive the stock material;
a spreader positioned downstream of the inner former with respect to the material path; and
a crumpler positioned downstream of the separator with respect to the material path and including compression members configured to compress a central portion of the overlapping layers of the stock material in a first direction, wherein the spreader is configured to maintain interior dimensions of the tube.

20. A device for producing dunnage from a stock material, comprising:
an inlet having a forming surface configured to bend the stock material in a direction of a material path of the stock material through the device while bending side edge portions of the stock material about a longitudinal centerline of the stock material as the stock material is drawn over the forming surface;
a former positioned downstream of the inlet with respect to the material path, the former including:
an outer former having an interior surface defining a passage configured to receive the inner former, the interior surface configured to bend the stock material into overlapping layers as the stock material moves through the passage in a downstream direction with respect to a material path of the stock material, and
an inner former having an outer surface, at least a portion of the outer surface opposing and being spaced from the interior surface of the outer former so that the outer surface and the interior surface of the outer former define a channel configured to receive the stock material; and
a crumpler positioned downstream of the former with respect to the material path and configured to compress the overlapping layers of the stock material.
